(19) United States
(12) Patent Application Publication
(10) Pub. No.: US 2024/0062090 A1
(43) Pub. Date: Feb. 22, 2024

(54) DETUNING-MODULATED UNIVERSAL COMPOSITE GATES

(71) Applicant: Ramot at Tel-Aviv University Ltd., Tel-Aviv (IL)

(72) Inventors: Haim SUCHOWSKI, Tel-Aviv (IL); Hadar GREENER, Tel-Aviv (IL); Elica KYOSEVA, Tel-Aviv (IL); Moshe GOLDSTEIN, Tel-Aviv (IL); Jonatan PIASETZKY, Tel-Aviv (IL); Muhammad EREW, Tel-Aviv (IL); Ido KAPLAN, Tel-Aviv (IL); Yaron OZ, Tel-Aviv (IL)

(73) Assignee: Ramot at Tel-Aviv University Ltd., Tel-Aviv (IL)

(21) Appl. No.: 18/382,511

(22) Filed: Oct. 22, 2023

Related U.S. Application Data
(63) Continuation of application No. PCT/IL2022/050414, filed on Apr. 21, 2022.
(60) Provisional application No. 63/177,975, filed on Apr. 22, 2021.

(51) Int. Cl. G06N 10/40; G06N 10/70

(52) U.S. Cl. CPC G06N 10/40; G06N 10/70

(57) ABSTRACT

A method for constructing a quantum gate for a unitary operation in photonic quantum information processing, comprises: providing two or more waveguides, calculating segment parameters for segments within a coupling region, said one or more parameters relating to propagation constants of respective waveguides, said one or more parameters being different for said first and second waveguides respectively and thereby providing detuning between said first and second waveguides to allow for unitary operation between said first and second waveguides with high fidelity in the presence of errors, then building the segments into the respective waveguides and optically coupling the waveguides at the coupling region using the segment parameters, thereby to construct a quantum logic gate for a unitary operation.

### RELATED APPLICATIONS

This application is a Continuation of PCT Patent Application No. PCT/IL2022/050414 having International filing date of Apr. 21, 2022, the benefit of priority under 35 USC § 119(e) of U.S. Provisional Patent Application No. 63/177,975 filed on Apr. 22, 2021. The contents of the above applications are all incorporated by reference as if fully set forth herein in their entirety.

### FIELD AND BACKGROUND OF THE INVENTION

The present invention, in some embodiments thereof, relates to a method and apparatus for quantum computing and, more particularly, but not exclusively, to detuning-modulated universal composite gates that may be used in quantum computing.

Quantum information processing (QIP) relies on high-fidelity quantum state preparation, transfer, unitary rotations and measurements. High-fidelity state preparation and population transfer are the building blocks of quantum information processing (QIP), where the admissible error of logical quantum operations is smaller than 10⁻⁴. This is challenging in experimental realizations of QIP, where any systematic error can reduce the state and gate fidelities below the 10⁻³ physical error threshold of fault-tolerance. One tool to correct for errors is composite pulses (CPs). These are a series of pulses with specifically calculated amplitudes and phases that, when applied in sequence, achieve accurate and robust quantum gates. CPs have been historically designed for resonant or adiabatic interactions with complex coupling parameters, realizing complete population transfer (CPT) in quantum systems by radiofrequency (rf) and ultrashort pulse excitations.

Recently, detuning-modulated composite segment sequences have been utilized to address the limitations of the aforementioned CPs, that require control of the phase of the coupling. Detuning-modulated composite segment sequences were created to be used in any qubit architecture, including integrated photonic circuits.

More recently, CPs were applied in many physical realizations of QIP including trapped ions and atomic systems, and also to achieve accuracy in matching higher harmonic generation processes and in designing polarization rotators. Another promising candidate for advancing QIP technologies is integrated photonic circuits due to their scalability and on-chip integration capacity. However, the fidelity of operations remains below the QIP threshold due to unavoidable fabrication errors. CPs have not been previously used to correct for such errors as existing sequences require control of the phase of the coupling, which in integrated photonic circuits is a real parameter.

Moreover, current qubit architectures require precise initial state preparation for the accurate application of quantum gates. Thus, there is an immediate need for feasible methods to design quantum gates that are independent of the system's initial state.

More particularly, recent advances in quantum computation and quantum technologies prompt an asserted need for experimentally reproducible techniques for fault-tolerant quantum information processing. This often requires high precision initial state preparation as well as unitary gates for optimal execution.

Composite pulses (CPs) are historically a series of segments with specifically chosen phases to enable complete population inversion in nuclear magnetic resonance experiments. Due to the simplicity of operation, they are currently used in many control schemes for a variety of physical systems. These include atomic systems, trapped ions and matching high harmonic generation in nonlinear optics. Recently, it was shown that by setting the detuning as the control parameter, one can feasibly apply composite pulses/sequence schemes to light transfer in coupled waveguide systems. Detuning-modulated composite pulses for integrated photonics and QIP is a scalable method with a small footprint that is very robust to errors in many system parameters, such as coupling, detuning and segment area. Therefore, this technique is advantageous for the fabrication of integrated photonic circuits which are prone to inevitable fabrication errors. In the quantum integrated realization, the above system parameters translate to distance between adjacent waveguides, differences in their geometries and overall lengths.

However, state preparation is only one aspect of quantum information device. The main core of the information processing procedure as well as quantum measurement rely on performing accurate unitary operations that are termed as quantum gates.

### SUMMARY OF THE INVENTION

The present embodiments may provide detuning-modulated universal composite segments that are independent of the system's initial state that give robust unitary rotations to implement various quantum gates, which work on all input quantum and classical states. Replacing transient pulses, the segments are physical structures on the coupling regions of waveguides. The present inventors use all degrees of freedom, including off-resonant detunings as control parameters to create families of such universal rotations and transformations. These composite segments may be robust to inaccuracies in segment strength, duration, resonance offset errors, Stark shifts, etc. within the lifetime of the system. Even in the presence of these systematic errors, the gates created are well within the physical error threshold suitable for quantum information processing.

The present embodiments may thus provide a method for quantum information processing and control to provide robust and accurate unitary gates. Such an operation is a universal rotation (UR) and it is different from point-to-point (PP) rotations in the sense that they are designed to drive a system to rotate around a certain axis and angle, instead of from a certain initial to a final point.

Detuning modulated composite segments may provide high-fidelity quantum operations for QIP, and particularly for integrated photonic systems for several reasons.

Thus, integrated photonics designed using universal detuning modulated composite segments (CSs) may consider input errors, and employ real-valued control knobs, suited for fabrication limitations.

Quantum operations designed for detuning modulated CSs are very robust and inherently stable to systematic errors, such as coupling strength, segment duration and detuning errors.

Detuning modulated CSs allow for minimal segment overhead; enabling robust population transfer even for as low as N=3, where N is the number of segments in the coupling region, resulting in shorter integrated components.

Universal detuning-modulated CSs allow for straightforward scaling for any arbitrary N-piece sequence, enabling for scaled components.

According to an aspect of some embodiments of the present invention there is provided a method for constructing a quantum gate for a unitary operation in photonic quantum information processing, comprising:
providing at least a first waveguide and a second waveguide;
calculating one or more segment parameters for segments within a coupling region, the one or more parameters relating to propagation constants of respective waveguides, the one or more parameters being different for the first and second waveguides respectively and thereby providing detuning between the first and second waveguides to allow for unitary operation between the first and second waveguides with high fidelity in the presence of errors;
building the segments into the respective waveguides; and
optically coupling the first and second waveguides at the coupling region, at least one of the building and the coupling being carried out using the one or more parameters, thereby to construct a quantum gate for a unitary operation.

In an embodiment, the one or more segment parameters comprise a parameter related to one member of the group comprising a width of one of the waveguides, a height of one of the waveguides, a refractive index of one of the waveguides, a doping level of one of the waveguides, and a distance between the first and second waveguides.

Embodiments may comprise providing each of the waveguides with a plurality of segments within the coupling region, each one of the segments being constructed according to a different segment parameter.

Embodiments may comprise using solutions for respective propagation constants wherein a number of the segments formed by respective calculated parameters is greater than or equal to two.

Embodiments may comprise making corrections to the one or more parameters using an analytical approach.

Alternatively or additionally, making corrections to the at least one parameter may use a numerical approach.

In embodiments, the numerical approach may be either of an iterative eigenmode expansion (EME) simulation process to approach a desired detuning level, and using a finite difference eigenmode solver (FDE) to calculate a coupling parameter.

The method may comprise changing a detuning parameter (δ), the δ and a change in δ being achieved by changing one of the segment parameters in the coupling region.

The method may comprise changing a coupling parameter (Ω), a change in Ω being defined by changing one of the segment parameters in the coupling region.

The method may comprise changing both the coupling parameter and the detuning parameter.

The method may comprise using detuning values Δ normalized by a coupling parameter κ representing the optical coupling between the first and second waveguides, to obtain the δ for a given detuning modulation.

Detuning may comprise changing one of the segment parameters in discrete steps.

The method may comprise using the discrete steps to arrive at a structure that allows universal rotations, the rotations being independent of an initial state of a system formed by the at least first and second waveguides being coupled.

The method may comprise providing an error model based on fabrication limitations and selecting the parameters via a stepwise process to minimize errors under the model.

In an embodiment, the errors are systematic errors.

According to a second aspect of the present invention there is provided quantum logic for unitary operation in quantum information processing comprising:
at least two optically coupled waveguides, coupled over a coupling area, the coupling area comprising at least two segments, the segments differing with respect to each other in respect of at least one segment parameter.

In an embodiment, the at least one segment parameter is one member of the group comprising a width of one of the waveguides, a height of one of the waveguides, a refractive index of one of the waveguides, a doping level of one of the waveguides, and a distance between the first and second waveguides.

In an embodiment, the segments and the optical coupling between the waveguides define detuning parameters δ and coupling parameters Ω, the segment parameters being selected to provide a detuned coupling between the first and second waveguides to provide reliable unitary operation between the first and second waveguides with high fidelity in the presence of errors.

In an embodiment, the first and second waveguides comprise Si on SiO₂, SiN, glass, or LiNBO₃ waveguides.

Embodiments may implement any of the group of logic gates comprising: an X gate, an H (Hadamard) gate, a

$${X}^{\frac{1}{n}}$$

gate, a NOT gate, a CNOT gate, a Y gate, a Z gate, a CZ gate, an iX gate, and a T gate.

According to a third aspect of the present invention there is provided a method for constructing an integrated photonic device to perform a unitary operation, comprising:
providing at least a first waveguide and a second waveguide;
calculating one or more segment parameters for segments within a coupling region, the one or more parameters relating to propagation constants of respective waveguides, the one or more parameters being different for the first and second waveguides respectively and thereby providing detuning between the first and second waveguides to allow for unitary operation between the first and second waveguides with high fidelity in the presence of errors;
building the segments into the respective waveguides; and
optically coupling the first and second waveguides at the coupling region, at least one of the building and the coupling being carried out using the one or more parameters, thereby to construct a quantum gate for a unitary operation.

In an embodiment, the one or more segment parameters comprise respective members of the group comprising a width of one of the waveguides, and a distance between the first and second waveguides.

According to a fourth aspect of the present invention there is provided a photonic device comprising at least two optically coupled waveguides, the waveguides coupled over a coupling area, the coupling area comprising at least two segments, the segments differing with respect to each other in respect of at least one segment parameter.

In particular examples that have been built, the first and second waveguides may have segments in the coupling region that are of height h=340 nm and h=220 nm and initial widths of w₀=220 nm and 400 nm. Widths can also be considerably wider, of 350 nm and greater.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1(a) is a schematic depiction of a two-level quantum system with coupling Ω and detuning Δ, according to embodiments of the present invention;

FIGS. 1(b)-(d) are NOT and pseudo-Hadamard quantum gates around the same torque vector (red) with different initial states (black vector) on the Bloch sphere, according to embodiments of the present invention;

FIG. 1(e) is a simplified flow chart illustrating construction of a quantum logic gate according to embodiments of the present invention;

FIGS. 2(a) and 2(b) are simplified diagrams which give a conceptual understanding of fidelity of detuning-modulated universal single-qubit gates according to embodiments of the present invention;

FIGS. 3(a) and 3(b) are simplified diagrams which illustrate infidelity (1-F) at a log scale of detuning modulated universal single-qubits at first and second order according to a first embodiment of the present invention;

FIGS. 4(a) and 4(b) are contour plots of the robustness of 1st- (a) and 2nd- order (b) universal it segments vs individual detuning δΔ/Δ and coupling δΩ/Ω errors according to the embodiment of FIG. 3A, FIG. 3B;

FIGS. 5(a) and 5(b) are contour plots displaying ranges of values through which individual coupling and detuning parameters may deviate according to the embodiment of FIG. 3A, FIG. 3B and yet achieve robust segments;

FIG. 6 is a simplified diagram which shows the infidelity, (1-F) , of universal π (red) and π/2 (blue) segments in log scale vs decay rate in units of Ω, according to the embodiment of FIG. 3A, FIG. 3B;

FIG. 7(a) schematically shows two coupled optical waveguides, situated at a distance of g from their center lines;

FIG. 7(b) is a view from above of the light intensity propagation of an N=6-segment coupled waveguide system that realizes the required changes in Δ to obtain a NOT gate according to the embodiment of FIG. 3A, FIG. 3B;

FIG. 7(c) is a Bloch sphere representation of the coupled waveguide system of FIG. 7(b);

FIG. 7(d) is a graph of state population vs time of a theoretical trajectory of a sequence according to the embodiment of FIG. 3A, FIG. 3B;

FIGS. 8(a) to 8(c) are three simplified diagrams showing a process of obtaining a coupling for waveguides according to embodiments of the present invention;

FIGS. 8(d) to 8(f) are three simplified diagrams showing the same process of obtaining a coupling for waveguides where detuning involves changing doping or refractive index, according to embodiments of the present invention;

FIGS. 9(a) to 9(c) are three simplified diagrams showing a process of obtaining detuning for the waveguides of FIGS. 8(a) to 8(c);

FIGS. 9(d) to 9(f) are three simplified diagrams showing a process of obtaining detuning for the waveguides of FIGS. 8(d) to 8(f);

FIG. 10(a) is a simplified diagram of a simple U gate, which is the basis for the gates in the present embodiments;

FIG. 10(b) shows the coupling area in FIG. 10(a);

FIG. 10(c) is a simplified explanatory view of a coupling area according to an embodiment of the present invention;

FIGS. 10(d) to 10(f) show three different embodiments of a single qubit composite U gate;

FIGS. 11(a) and 11(b) are simplified diagrams of two examples of multiple qubit composite gates according to embodiments of the present invention;

FIG. 11(c) illustrates a Mach Zender interferometer constructed according to embodiments of the present invention;

FIGS. 12(a) to 12(d) illustrate parameters obtained in a numerical optimization process for an X gate according to embodiments of the present invention;

FIGS. 13(a) to 13(d) illustrate parameters obtained in a numerical optimization process for an X^{1/2} gate according to embodiments of the present invention;

FIGS. 14(a) to 14(d) illustrate parameters obtained in a numerical optimization process for an X^{1/3} gate according to embodiments of the present invention;

FIGS. 15(a) to 15(d) illustrate parameters obtained in a numerical optimization process for an H, or Hadamard, gate according to embodiments of the present invention;

FIGS. 16(a) to 16(d) illustrate parameters obtained in a numerical optimization process for T gate according to embodiments of the present invention;

FIGS. 17(a) to 17(c) illustrate parameters obtained in a numerical optimization process for a CNOT gate according to embodiments of the present invention;

FIGS. 18(a) to 18(c) illustrate parameters obtained in a numerical optimization process for CZ gate according to embodiments of the present invention;

FIGS. 19(a) to 19(i) illustrate the results of analytical methods to obtain the parameters for gates according to embodiments of the present invention;

FIGS. 20(a) to 20(g) illustrate the results of analytical methods to obtain the parameters for further gates according to embodiments of the present invention;

FIGS. 21(a) to 21(h) illustrate the results of analytical methods to obtain the parameters for yet further gates according to embodiments of the present invention; and

FIGS. 22(a) 22(c) illustrate stability regions for naive and composite solutions according to embodiments of the present invention.

### DESCRIPTION OF SPECIFIC EMBODIMENTS OF THE INVENTION

The present invention, in some embodiments thereof, relates to use of detuning modulation to construct universal composite logic gates for use in quantum computing.

As discussed, the present embodiments may provide detuning-modulated universal composite pulses and provide methods for robust unitary rotations, which works on all input quantum/classical states, to implement various quantum gates, as opposed to the prior art which required the system to be at the ground (or excited) state. Embodiments may use all degrees of freedom, including off-resonant detunings, as control parameters to create a family of such universal rotations. These segments are robust to inaccuracies in segment strength, duration, resonance offset errors, Stark shifts, etc. within the lifetime of the system. The gates created are well within the error threshold suitable for quantum information processing.

The present embodiments may further provide a family of universal detuning-modulated composite segments (CSs) to enable high-fidelity within the quantum error threshold of 10⁻⁴. This approach allows for low segment overhead, where the shortest segment is composed of N=3 components. The present solutions are inherently stable to various system parameters, such as coupling, detuning and segment duration. The present scheme is robust with both the amplitude and phase.

The present embodiments are suitable for, but not limited to, implementation in integrated photonic circuits, which are considered a strong candidate for quantum information processing (QIP) hardware. Integrated photonic circuits are prone to fabrication errors, which lead to a decrease in the produced signal fidelity, thus limiting their application in QIP. Moreover, precise quantum state preparation in integrated photonics requires an additional preliminary process, which adds to the complexity of scaling-up device fabrication. Universal detuning-modulated composite pulses enable the production of photonic gates without rigid requirements of the input signal.

More particularly, composite segments (CS) are historically a series of segments with specifically chosen phases to enable complete population inversion in nuclear magnetic resonance experiments. Due to the simplicity of operation, they are currently used in many control schemes for a variety of physical systems. These include atomic systems, trapped ions and matching high harmonic generation in nonlinear optics. Recently, it was shown that by setting the detuning as the control parameter, one can feasibly apply composite pulses schemes to light transfer in coupled waveguide systems. Detuning-modulated composite pulses for integrated photonics and QIP is a scalable method with a small footprint that is very robust to errors in many system parameters, such as coupling, detuning and segment area. Therefore, this technique is advantageous for fabrication of integrated photonic circuits which are prone to inevitable fabrication errors. Here, the above system parameters could translate to distance between adjacent waveguides, differences in their geometries, different segment's doping, segment's temperature, applied electrical electromagnetic field and segment's length overall lengths.

Universal detuning-modulated CSs may contribute an additional layer to the previous scheme, and may enable accurate and robust state transfer that is independent of the initial state. Thus, the operation performed on the system remains exact, even if the input signal to the physical system was not. Following the example of a coupled waveguide system, the total light intensity input to one waveguide may be coupled with high accuracy to the adjacent waveguide, notwithstanding its value.

There exist two classes of composite pulses: Point-to-point rotations (PP) and unitary rotations (UR). Point-to-point rotations execute a rotation from a specific initial state to a specific final state. Unitary rotations are designed to execute a rotation of a specific angle around the rotation axis and angle for any arbitrary initial state which allow simultaneous rotation of all quantum states

It has been shown that a UR can be constructed by a palindromic time-reversed series of PP rotations. In the present embodiments, we construct unitary rotations from a series of sign-reversed palindromic detuning-modulated CSs. We achieve highly accurate arbitrary state transfer, which is robust to errors in various system parameters. Our method allows for minimal segment overhead, enabling such operation for N>=4 ingredient segments, resulting in high fidelity QIP within the lifetime of the physical system.

Detuning modulated composite pulses are a cornerstone for high-fidelity quantum operations for QIP, and particularly for integrated photonic systems for several reasons:
Integrated photonic CS designed using universal detuning modulated composite pulses (CS) are able to consider fabrication errors, and employ real-valued coupling parameters as the control knobs.
Quantum operations designed for detuning modulated CSs are very robust and inherently stable to systematic errors, such as coupling strength, segment duration and detuning errors.
Detuning modulated CSs allow for minimal segment overhead enabling robust population transfer even for N=3, resulting in shorter integrated components.
Universal detuning-modulated CSs allow for straightforward scaling for any arbitrary N-piece sequence, enabling for scaled components.

A method for unitary operation in photonic quantum information processing, according to the present embodiments thus comprises obtaining an optical beam or a single photon in a superposition quantum state; optically coupling a first waveguide to a second waveguide, the two waveguides having different detuning (caused by different widths, heights, doping, index of refraction, temperatures, or any parameter that changes the relative mode-index/propagation constant between the couples waveguides); and providing the beam to the optically coupled waveguides to detune the beam, the detuning or phase mismatch being a function of the different widths, so that the detuned coupling provides reliable light intensity transfer between the waveguides. The method comprises detuning by applying a step change by an amount δ in a width of one of the optically coupled waveguides, δ being selected as a function of the propagation constants.

Unitary detuning-modulated CSs may contribute an additional layer to the previous scheme, and enables accurate and robust state transfer that is independent of the initial state. Detuning-modulated composite pulses utilize off-resonant detunings as control parameters to create a composite N-step evolution of a quantum unitary operation. Here we detail new families of unitary detuning-modulated composite pulses enable robust high-fidelity. This approach allows for low sequence overhead. The present embodiments are inherently stable to various system parameters, such as coupling, detuning and sequence duration/length. This technique is suitable for, but not limited to, implementation in integrated photonic circuits, which are considered a strong candidate for QIP hardware. Integrated photonic circuits are prone to fabrication errors, which lead to a decrease in the produced signal fidelity, thus limiting their application in QIP.

In an embodiment, the error is modeled according to the fabrication limitations, and a segmentation scheme is generated, that reduces susceptibility to the specific error model.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

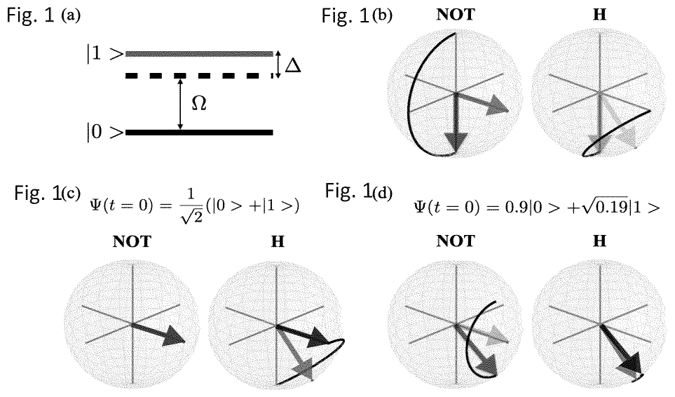

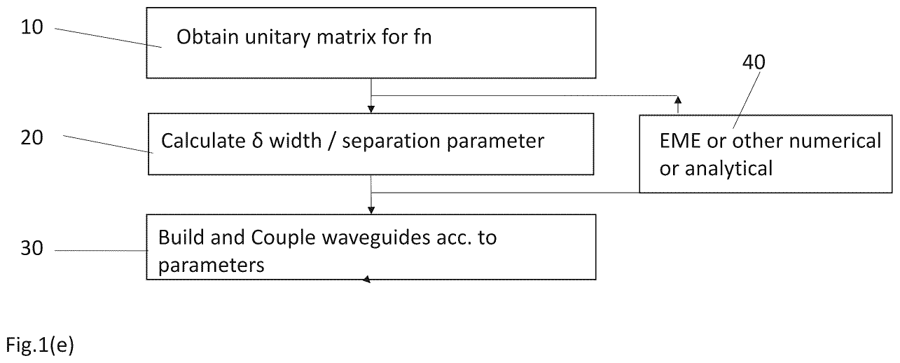

The present embodiments may provide universal detuning-modulated composite segment sequences, excluding any constraint on the coupling strength. The term ‘universal’ means herein that the CSs create quantum gates, thus creating the desired rotations around the same torque vector on the Bloch sphere, as depicted in FIGS. 1(a) to 1(d). In quantum computing, the Bloch sphere is a geometrical representation of the pure state space of a two-level quantum mechanical system (qubit). Quantum mechanics is mathematically formulated in Hilbert space. The pure states of a quantum system correspond to the one-dimensional subspaces of the corresponding Hilbert space. For a two-dimensional Hilbert space, the space of all such states is the complex projective line CP. This is the Bloch sphere. The Bloch sphere is a unit-sphere, with antipodal points corresponding to a pair of mutually orthogonal state vectors. The north and south poles of the Bloch sphere are typically chosen to correspond to the standard basis vectors |0 [symbol] and |1 [symbol] , respectively, which in turn might correspond e.g. to the ground and excited states of an electron. This choice is arbitrary, however. The points on the surface of the sphere correspond to the pure states of the system, whereas the interior points correspond to the mixed states.

FIG. 1(a) is a schematic depiction of a two-level quantum system with coupling Ω and detuning Δ. FIGS. 1(b)-(d) are NOT, x-gate, and pseudo-Hadamard quantum gates around the same torque vector (red) with different initial states (black vector) on the Bloch sphere. FIG. 1(b) shows the system initially in the ground state. FIG. 1(c) shows a superposition state, and FIG. 1(d) shows a mixed state.

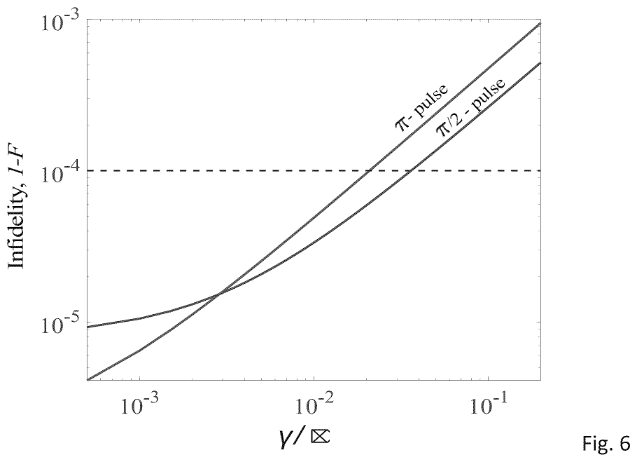

The present sequences exhibit high fidelity in the presence of errors in various parameters including coupling, segment area, segment duration, phase jitter, and detuning, well within the qubit's lifetime, as will be discussed in greater detail hereinbelow with respect to FIG. 6. The general method to derive detuning-modulated segments of an arbitrary length N has a minimal pulse overhead, such that robust gates are realized for universal sequences as short as N=3. The following analysis considers the canonical two-state quantum system. We note that many physical realizations are possible, such as atomic and photonic systems.

Referring now to FIG. 1(e) there is shown a method for constructing a quantum gate for quantum information processing according to an embodiment of the present invention. The process requires two or more waveguides depending on the logic gate being constructed and the number of inputs. In general, quantum logic gates are implementations of unitary matrices, box 10, and when using photonic optics as the basis for the quantum implementation, each waveguide provides an input state. Thus the appropriate number of waveguides is provided and certain parameters, hereinafter segment parameters, are calculated, box 12, relating to the geometry of the coupling between the waveguides. The parameters may relate to changes in the width or height of the waveguide in the coupling area and/or the distance between the waveguides in the coupling area, or indeed anything to do with the waveguide geometry and propagation within the waveguide. Thus the refractive index, the doping, even the temperature may affect propagation. Parameters to do with the propagation within the waveguide contribute to a detuning constant. Parameters to do with coupling between the waveguides, such as the distance between the segments of the different waveguides in the coupling area, contribute to the coupling constant.

The relationship between the various segment parameters and the detuning and coupling constants is not easy to calculate. Particular detuning and coupling constants that are advantageous in terms of providing robustness to manufacturing errors may be calculated, but that has to be translated into physical structure in the segments and in the distances between the waveguides in the coupling area.

In one embodiment, only the detuning constant is calculated, and the segments are built accordingly. In another embodiment, both segment and coupling constants are calculated and the segments and coupling distances are set accordingly. Embodiments may include single or multiple changes in the various parameters to give different numbers of segments, sizes of segments, distances between the waveguides etc. Detuning occurs due to having differences between facing segments of coupled waveguides.

If both the detuning and coupling is attended to together then it is possible to arrive at a solution that supports unitary functions with universal rotation. If only the detuning is attended to, then the function is point-to-point, as will be explained in greater detail below.

Once the parameters are calculated, a quantum gate may be constructed, box 30, by building the segments into the coupling region and optically coupling the waveguides, according to the calculated parameters. The quantum gate is thus able to carry out unitary operations as defined by the corresponding unitary matrix. The parameters may be recalculated and implemented stepwise in an iterative process or analytical calculation or in numerical optimization.

Solutions for respective propagation constants may specifically involve numbers of segments, that is values of n, from 3 upwards, and particularly n=4 or n=6.

The solution may involve applying corrections to the one or more segment parameters in a numerical approach, and the correction may use analytical or numerical optimization, box 40, for example an iterative eigenmode expansion (EME) simulation process to approach a desired detuning level.

As mentioned, one parameter is the detuning parameter (δ), where δ may be related to changes in propagation between the coupled waveguides due to the structures of the segments. If the two waveguides have the same geometry, refractive index etc., then they are tuned, so the difference in width may define a detuning, but a simple difference in width is not enough, as the result may be highly sensitive to manufacturing errors in achieving the desired width.

The other parameter to consider is the coupling parameter (Ω), where Ω is related to the coupling between the waveguides. Different combinations of one or more of either parameter may be used, including the width parameter alone.

A finite difference eigenmode solver (FDE) may be used to calculate the coupling parameter numerically.

The detuning between the waveguides may be attempted analytically or may involve changing one or other of the parameters numerically, say using a stepwise or iterative process starting with a naïve parameter or guess, for example, one of the methods mentioned above. The detuning may thus involve stepwise changing of the width w of one of said waveguides or the distance between the waveguides in discrete steps. The aim of the steps, at least in the second embodiment below, is to arrive at a solution that allows universal rotations. A universal rotation is a rotation that is independent of the initial state of a system formed by the coupled waveguides.

### Detuning-Modulated Composite Pulses

The Schrödinger equation governs the temporal evolution of a qubit system {|0 [symbol] , |1 [symbol] } driven coherently by an external electromagnetic field in the following way:

$$i ℏ {\partial }_{t} ( \begin{matrix}{c}_{1} ( t ) \\ {c}_{2} ( t )\end{matrix} ) = \frac{ℏ}{2} [ \begin{matrix}- Δ ( t ) & Ω ( t ) \\ {Ω}^{*} ( t ) & Δ ( t )\end{matrix} ] ( \begin{matrix}{c}_{1} ( t ) \\ {c}_{2} ( t )\end{matrix} ) , \qquad ( 1 )$$

where [c₁(t), c₂(t)]^{T} is the probability amplitudes vector, Ω(t) is the Rabi frequency of the transition between the states of the system, and Δ(t)=ω₀−ω is the real-valued detuning between the laser frequency ω and the Bohr transition frequency of the qubit ω₀. In the following, we assume Ω(t) and Δ(t) real and constant; however, our results are straightforward to extend to complex values.

The unitary propagator of the time evolution governed by Eq. (1) is found according to

$$U ( t , 0 ) = {e}^{- i / ℏ {\int }_{0}^{t}} H ( t ) dt ,$$

$$U ( δ t ) = ( \begin{matrix}cos ( \frac{A}{2} ) + i \frac{Δ}{{Ω}_{g}} sin ( \frac{A}{2} ) & - i \frac{Ω}{{Ω}_{g}} sin ( \frac{A}{2} ) \\ - i \frac{Ω}{{Ω}_{g}} sin ( \frac{A}{2} ) & cos ( \frac{A}{2} ) - i \frac{Δ}{{Ω}_{g}} sin ( \frac{A}{2} )\end{matrix} ) . \qquad ( 2 )$$

where Ω_{g}=√Ω̅²̅+̅Δ̅²̅ is the generalized Rabi frequency and A=Ω_{g}δt is the segment area with Δt=(t−t₀) the segment duration. The evolution of the state of the qubit by the propagator U(δt) from the initial time t₀ to the final time t is c(t)=U(δt)c(t₀). If the initial state of the qubit at t₀ is |0 [symbol] , the population of the excited state |1 [symbol] at time t is found by the modulus squared of the off-diagonal propagator element |U₁₂(δt)|².

We follow the recent methodology reported for deriving detuning-modulated composite segment sequences comprised of N individual off-resonant segments with Rabi frequencies Ωₙ and detunings Δₙ. Namely, given the individual segment propagator Uₙ(δtₙ) from Eq. (2), the propagator for the total composite segment sequence is given by the product

U^{(N)}(T,0)=U_{N}(δt_{N})U_{N-1}(δt_{N-1}) . . . U₁(δt₁), (3)

where δtₙ=(tₙ−tₙ₋₁) is the duration of the n^{th} segment (t₀=0 and t_{N}≡T).

### Universal Single-Qubit Gates

Universal, robust gates are generally difficult to implement with tailored segments. A first embodiment based on composite pulses focuses on achieving a stable bit flip realization only for an initial state of the system, either |0 [symbol] or |1 [symbol] . Below, we show the first detuning-modulated composite pulses for implementing any single-qubit gate for any initial qubit state. Initially, we show a system that is robust for amplitude and not for phase and then we show a system that is robust for both amplitude and phase. Later, two and multi qubit operations are shown.

State-independent single-qubit gates are generally difficult to design, thus in the following, we present a recipe, first for a system that is robust for amplitude alone. We begin by differentiating between two different types of segments—point-to-point (PP) and universal rotations (UR). The first are constructed to transform a given state to a desired final state, while the latter is designed to create a given rotation around a specific axis and angle for any arbitrary initial state. It was shown that a UR segment for a rotation angle θ can be constructed from a PP segment with half the angle θ/2.

In this work, we construct universal rotations from a series of sign-reversed palindromic detuning-modulated CSs. In order to create a rotation by the angle θ around axis k, the unitary transformation Uₖ(θ)=e^{-iθI}^{ₖ} can be decomposed to two consecutive rotations of angle θ/2 around the k axis. Explicitly, a θ rotation around the the x axis is decomposed to two PP segment sequences:

Uₓ(θ)=V(ν)V^{tr}(ν) (4)

where V(ν) is the propagator describing a θ/2 rotation PP sequence and V^{tr}(ν) is its time and phase-reversed counterpart.

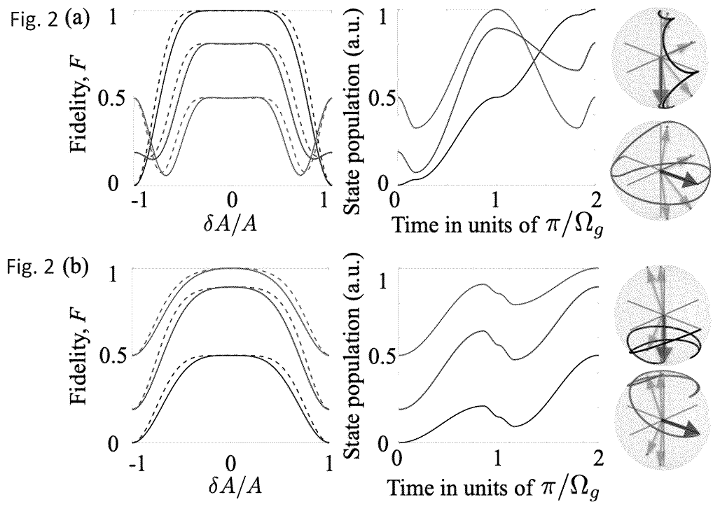

Reference is now made to FIGS. 2(a) and 2(b), which illustrate fidelity of detuning-modulated universal single-qubit gates. In each figure the right hand side shows the fidelity of first-(continuous lines) and second-order (dashed lines) segments The left hand side shows initial state population against time for each gate and the corresponding trajectories on the Bloch sphere. FIG. 2(a) shows the fidelity of it gate to errors in the segment area for different initial states |0 [symbol] (black), (|0 [symbol] +|1 [symbol] )/√2 (red) and 0.9 (blue) and FIG. 2(b) shows the case of fidelity of π/2 gate to errors in the segment area for different initial states |0 [symbol] (black), (|0 [symbol] +|1 [symbol] )/√2 (red) and 0.9 (blue).

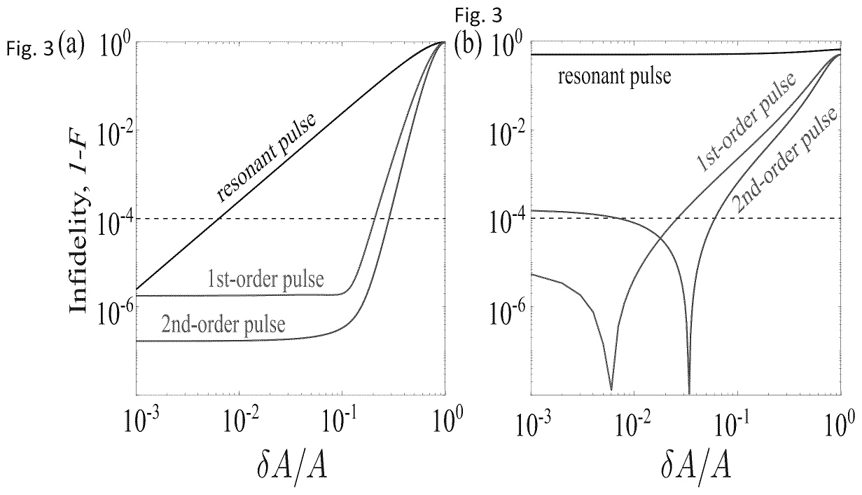

Reference is now made to FIGS. 3(a) and 3(b) which illustrate Infidelity (1-F) at a log scale of detuning-modulated universal single-qubit 1st-(red) and 2nd-order (blue). FIG. 3(a) is the case of π gates to segment area errors and FIG. 3(b) is the case of π/2 gates to segment area errors. The figures show the 10⁻³ QIP infidelity threshold and the resonance segment infidelity in black for reference.

### Universal π Rotations

Consistent with the above derivations, we employed the formalism which describes construction of a universal rotation from point-to-point transformations to derive universal detuning-modulated segment sequences, in an example for two gates. Instead of phase sign changes, we reversed the sign of the detunings calculated for half the target rotation angle values of a detuning-modulated CS.

To achieve the N=4 universal π segment, we calculated a N=2 detuning-modulated π/2 segment sequence. An equal superposition between the two qubit states is realized when a single-qubit rotation T is at an angle θ=π/2:

T=[cos θ−i sin θ−i sin θcos θ]. (5)

Focusing on the shortest sequence with N=2, the condition for the off-diagonal composite propagator element reads:

$${U}_{12}^{( 2 )} = \frac{\frac{{Δ}_{1}}{{Ω}_{1}} - \frac{{Δ}_{2}}{{Ω}_{2}}}{\sqrt{1 + \frac{{Δ}_{1}}{{Ω}_{1}}} \sqrt{1 + \frac{{Δ}_{2}}{{Ω}_{2}}}} = - 1 / \sqrt{2} . \qquad ( 6 )$$

Solving equation (6) for one of the independent parameters,

$$\frac{{Δ}_{1}}{{Ω}_{1}} ,$$

we find that it is satisfied for

$$\frac{{Δ}_{1}}{{Ω}_{1}} = ( - 1 - \frac{{Δ}_{2}}{{Ω}_{2}} ) / ( - 1 + \frac{{Δ}_{2}}{{Ω}_{2}} ) and \frac{{Δ}_{1}}{{Ω}_{1}} = ( - 1 + \frac{{Δ}_{2}}{{Ω}_{2}} ) ( 1 + \frac{{Δ}_{2}}{{Ω}_{2}} ) .$$

For a 1st-order sequence, this solution is plugged into the second derivative of |U₁₂⁽²⁾|² with respect to A at A=π and we find its roots:

$$( \frac{{Δ}_{1}}{{Ω}_{1}} , \frac{{Δ}_{2}}{{Ω}_{2}} ) = \pm ( - 5.52 , 0.69 ) , \qquad ( 7 )$$

This gives the interaction parameters of a 2-segment sequence that produces a robust detuning-modulated π/2 segment.

Thus, the shortest universal detuning-modulated sequence is a 1st-order N=4-piece segment with Δᵢ=(5.52, 0.69, −0.69, −5.52)Ω. Such a sequence enables a π rotation, or a quantum Pauli Y-gate for any initial qubit state that is robust to errors in target segment areas, detuning and coupling.

To increase robustness to the above errors, we solved for longer sequences, nullifying up to the sixth derivative of |U₁₂⁽²⁾|² with respect to A at A=π. We show the shortest solutions in Table 1.

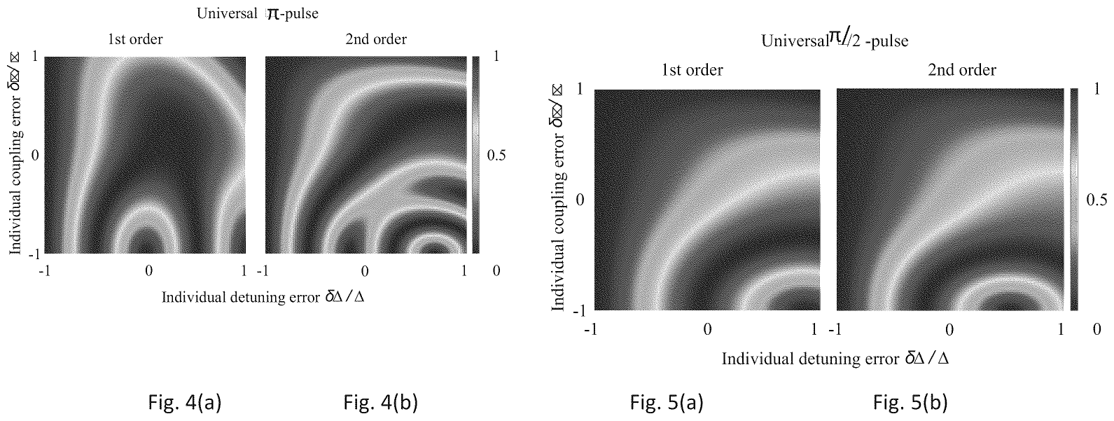

Reference is now made to FIGS. 4(a) and 4(b), which are contour plots of the robustness of 1st- (a) and 2nd- order (b) universal π segments vs individual detuning δΔ/Δ and coupling δΩ/Ω errors.

TABLE 1

| N | Order | $( \frac{{Δ}_{1}}{{Ω}_{1}} , \frac{{Δ}_{2}}{{Ω}_{2}} , … , - \frac{{Δ}_{2}}{{Ω}_{2}} , - \frac{{Δ}_{1}}{{Ω}_{1}} )$ |
|---|---|---|
| 4 | 1 | (5.52, 0.69, −0.69, −5.52) |
| 6 | 1 | (5.89, 1.01, −5.68, 5.68, −1.01, −5.89) |
| 6 | 1 | (1.43, 1.21, −1.17, 1.17, −1.21, −1.43) |
| 6 | 1 | (−1.21, 1, 1.22, −1.22, −1, 1.21) |
| 6 | 2 | (−4.29, −2.12, 1.54, −1.54, 2.12, 4.29) |
| 6 | 2 | (1.56, −2.04, −4.07, 4.07, 2.04, −1.56) |

### Universal π/2 Rotations

In order to create universal π/2 rotations, or robust pseudo-Hadamard single-qubit gates, we applied the above technique to first derive a detuning-modulated N=2π/4 segment sequence. Then we reversed the sign of the detuning to create a universal sequence with Δᵢ=(−1.94, −11.99, 1.94, 11.99)Ω. The shortest sequences are shown in Table 2.

TABLE 2

| N | Order | $( \frac{{Δ}_{1}}{{Ω}_{1}} , \frac{{Δ}_{2}}{{Ω}_{2}} , … , - \frac{{Δ}_{2}}{{Ω}_{2}} , - \frac{{Δ}_{1}}{{Ω}_{1}} )$ |
|---|---|---|
| 4 | 1 | (−1.94, −11.99, 1.94, 11.99) |
| 6 | 1 | (−19.87, −1.86, −19.87, 19.87, 1.86, 19.87) |
| 6 | 1 | (−0.97, 0.97, 0.37, −0.37, −0.97, 0.97) |
| 6 | 2 | (−1.74, −6.76, −52.23, 52.23, 6.76, 1.74) |

FIGS. 5(a) and 5(b) and FIG. 6 show the fidelity of the segments vs target coupling and detuning values. The contour plots of FIGS. 5(a) and 5(b) display a range of values through which individual detuning and coupling parameters can deviate from their prescribed values and yet achieve robust universal π and π/2 segments. Specifically, FIG. 5(a) shows a contour plot of the robustness of 1st-order universal π/2 segments vs individual detuning δΔ/Δ and coupling δΩ/Ω errors FIG. 5(b) shows the robustness of the second order universal π/2 segments vs individual scaled detuning δΔ/Δ and coupling δΩ/Ω errors.

FIG. 6 shows the infidelity, 1-F, of universal π (red) and π/2 (blue) segments in log scale vs the decay rate in units of Ω.

Composite sequences are comprised of a series of segments, thus their overall implementation time is longer than that of a single resonant segment. Therefore, one must test their fidelity against the system's lifetime. Substituting Δ→Δ−iγ in the diagonal elements of the Hamiltonian, we find the probability amplitude of each state according to |cᵢ(t)|²e^{-γt/2}, where γ is the characteristic relaxation time of the system in which T₁=γ⁻¹. For free decay, T₁ is independent of T₂, and there is an upper limit for the decoherence rate T₂≤2T₁. FIG. 6 presents the robustness of both the π and π/2 gates with respect to γ. We considered experimentally reported values of γ of the order of Ω to show that our segments are robust to decoherence and that their implementation time is well within the decay rate of the qubit.

### Realization in Directional Waveguide Couplers

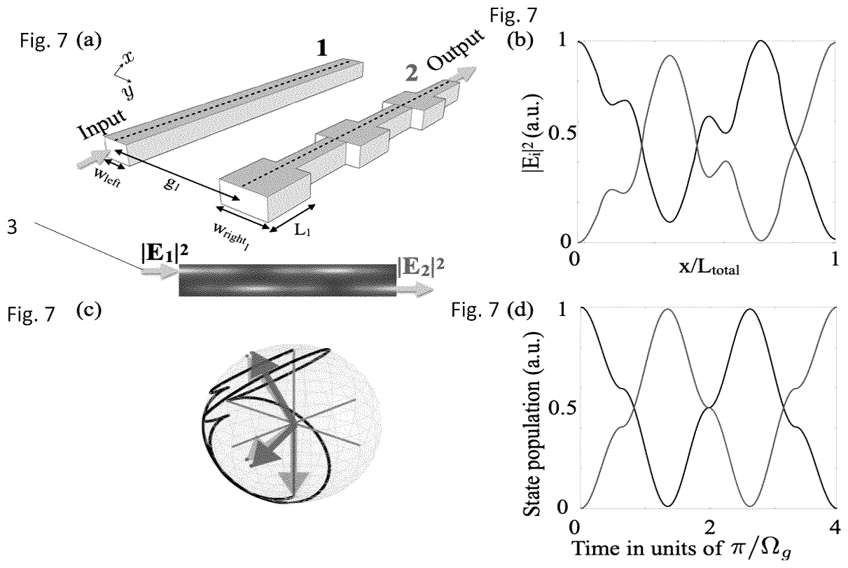

As detuning-modulated CSs enable implementation in systems with real-valued couplings, it is straightforward to realize the above universal sequences in coupled waveguide systems. Universal detuning-modulated CSs not only allow to overcome inevitable fabrication errors in such integrated devices, but relax the need for precise initial state preparation in order to achieve accurate gate operations. FIG. 7(a) schematically shows two coupled optical waveguides, situated at a distance of g from their center lines. The amplitudes of the fundamental modes in the waveguides follow the coupled mode approximation. Similar to equation [1], the coupling is Ω=ae^{-bg}, where a, b are material and geometry-dependent. The system is said to be on resonance if the two waveguides are identical in material and geometry, otherwise there exists a real-valued phase mismatch between the propagation constants βᵢ, Δ=0.56(β₁−β₂). The universal detuning-modulated CSs can be applied to such a system by varying the relative widths of the waveguides to create discrete changes of Δ along the propagation axis.

More generally, FIG. 7A shows two coupled waveguides forming a gate for state transfer in quantum information processing. The first waveguide has a first width and a first propagation constant for a given beam wavelength. The second waveguide has a second width differing by an amount δ from said first width, the second waveguide having a second propagation constant for a given beam wavelength.

The waveguides are optically coupled to each other at a separation Ω and the difference in width δ or the separation Ω are selected to modify a detuning parameter. The detuning parameter being modified is the difference between the propagation constants (which are functions of the mode index and geometry) of the individual waveguides. The use of the parameter may provide a detuned coupling between the waveguides to provide reliable unitary operation in the gate with high fidelity in the presence of errors.

The first and second waveguides may be Si on SiO₂ waveguides. Examples for the waveguides are to have height h=340 nm or h=220 nm and initial widths of w₀=220 nm or 400 nm.

FIG. 7(b) is a top view of the light intensity propagation of an N=6-segment coupled waveguide system that realized the required changes in Δ to obtain a NOT gate. This was simulated via an eigenmode expansion solver (EME). The light intensity at the center line of each waveguide is plotted to stress the complete light switching in the coupled system.

More particularly, FIGS. 7(a)-(d) show complete light transfer in a 1st-order N=6 universal detuning-modulated composite waveguide coupler. FIG. 7(a) shows an out-of-scale schematic of the waveguide design. Light is initially input in waveguide 1 and is transferred to waveguide 2. Numeral 3 denotes an EME calculation of light intensity of the coupled waveguide system. FIG. 7(b) shows a graph of the EM intensity in the middle of waveguide 1 (black, initially populated) and waveguide 2 (red, initially empty) vs. normalized propagation length. FIG. 7(c) is a Bloch sphere representation and FIG. 7(d) is a graph of state population vs time of a theoretical trajectory of the above sequence.

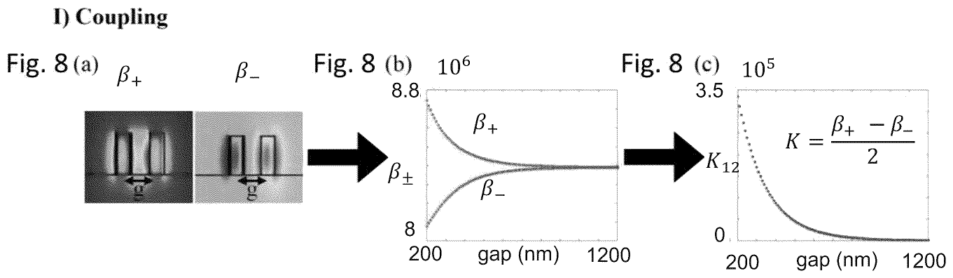

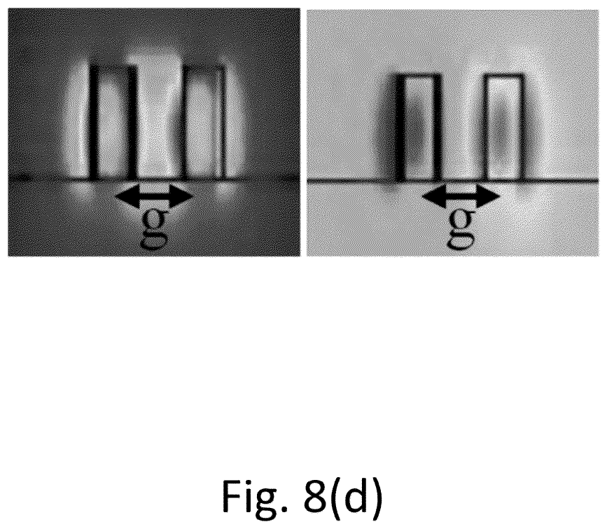

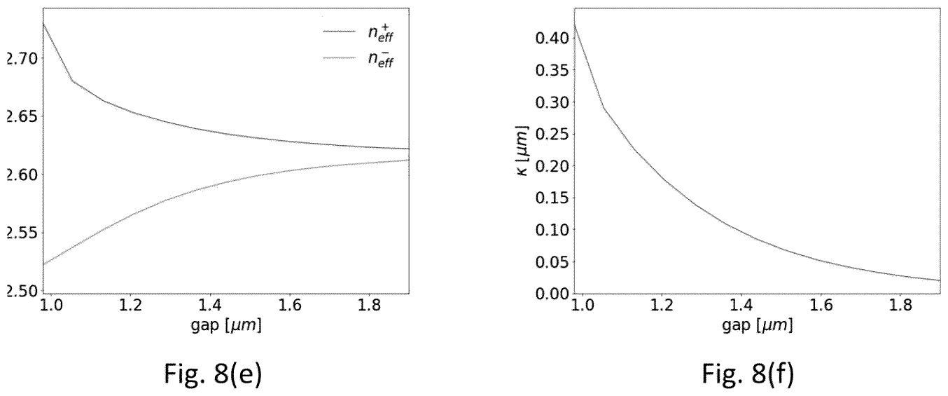

FIGS. 8(a)-8(c) show how the coupling between the two waveguides in FIGS. 7(a)-(d) may be affected by changing the gap g between the two waveguides.

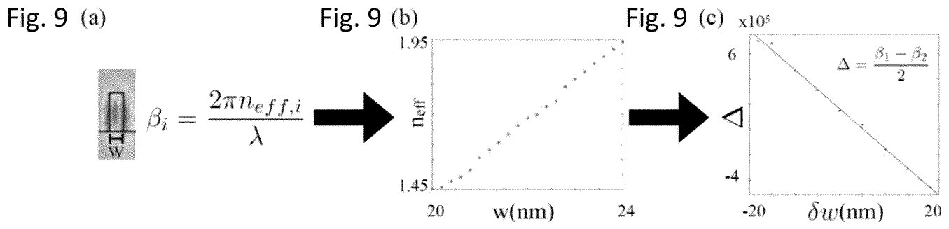

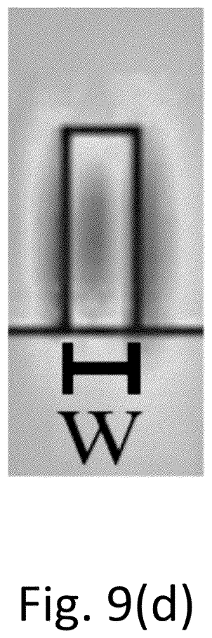

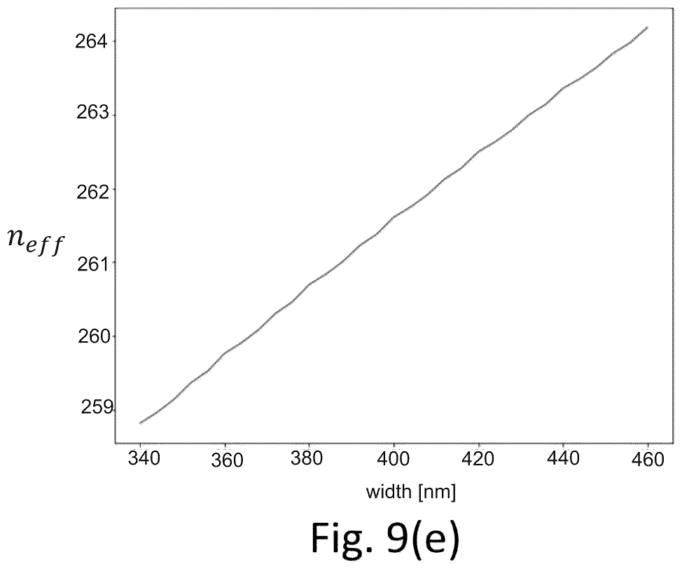

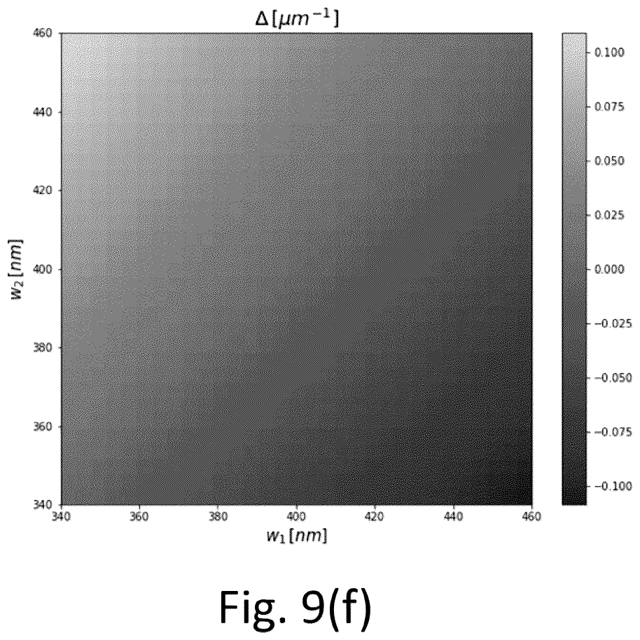

FIGS. 9(a)-9(c) show how detuning is affected by changing the width w of the waveguide. The width is varied in a discrete (sharp) manner as shown by the step changes in width in FIGS. 7(a)-(d). The values of step change used realize universal rotations which are independent of the initial state of the system.

More particularly, FIGS. 8(a)-9(c) illustrate realization in coupled waveguide systems, wherein universal rotations according to the present embodiments may be applied. Scalable components with high fidelity and robustness to fabrication and systematic errors may provide commercially useable components. In the physical configuration shown in FIGS. 8(a)-9(c), the coupling is set by the separation between two waveguides, the detuning (phase mismatch) is governed by the difference in the geometry of each waveguide and the segment area is determined by the length of each composite segment.

Within the coupled-mode approximation, the amplitudes of the fundamental modes in the waveguides obey an equation analogous to the Schrodinger equation referred to above, namely:

$$i ℏ {\partial }_{t} [ \begin{matrix}{c}_{1} ( t ) \\ {c}_{2} ( t )\end{matrix} ] = \frac{ℏ}{2} [ \begin{matrix}- Δ ( t ) & Ω ( t ) \\ {Ω}^{*} ( t ) & Δ ( t )\end{matrix} ] [ \begin{matrix}{c}_{1} ( t ) \\ {c}_{2} ( t )\end{matrix} ]$$

where the coupling is Ω=ae^{-bg} (a and b are material/geometry dependent).

For constant g, the coupling is also constant throughout the propagation length. The system is considered at resonance if the waveguides have identical geometries, otherwise there is a real valued phase mismatch Δ=(β₁−β₂)/2 with βᵢ being the respective propagation constants. Thus, the segment sequences of the present embodiments may be implemented by changing the waveguides' widths such that there are step changes in Δ along the length.

Detuning-modulated CSs allow for minimal segment overhead, which translates to shorter component lengths (from N=2). Thus, functionality does not depend strongly on the total length, allowing for compact, minimal-footprint devices. Moreover, detuning-modulated CSs allow for straightforward scaling for any arbitrary N-piece sequence, and enabling for scalable components.

A scheme for designing a two-waveguide coupler is shown in FIGS. 8(a)-9(c) for a Si on SiO₂ waveguide system. FIGS. 8(a) to 8(c) show the coupling parameter as a function of the distance between the waveguides' centerlines, g, for such a system with base widths of w=220 nm or w=400 nm and height h=340 nm or 220 nm for each waveguide. In order to calculate the coupling, we employed a FDTD Comsol Multiphysics simulation, although Lemrical and Matlab are also suitable, on the coupled system while sweeping g. In FIGS. 9(a)-9(c), the steps taken to calculate the detuning parameter are shown. First, we employed the FDTD simulation on a single waveguide with the above parameters while sweeping its width, w, in order to calculate the propagation constant as a function of the width. Next, we calculated the detuning of the coupled waveguide system as a function of the difference in the waveguides' respective widths. That is to say, FIGS. 8(a) to 9(c) are a flow chart for determining the geometrical parameters demanded for specific couplings (a) and detunings (b) of a detuning-modulated coupled waveguide system. All calculations herein are performed via a FDTD Comsol Multiphysics or Lumerical or matlab simulation.

### Schematic of Realization in Quantum Integrated Photonics

FIGS. 8(a)-8(c) in respect of coupling and FIGS. 9(a) to 9(c) in respect of detuning are now considered in greater detail. A scheme is provided that translates the universal detuning-modulated CP theory to a realization in quantum integrated photonics with physical segments—CS. We consider Si on SiO₂ (SOI) waveguides of height h=340 nm or 220 nm and base widths of w₀=220 nm or w=400 nm. The resonant coupling Ω is assessed via a finite difference eigenmode (FDE) solver by evaluating the symmetric β₊ and anti-symmetric β₋ modes as a function of the distance g between the two identical waveguides, where Ω=(β₊−β₋)/2 as shown in FIGS. 8(a) to 8(c).

Specifically, FIGS. 8(a) to 8(c) show that a finite difference eigenmode solver (FDE) is used to calculate the coupling parameter κ of two identical Si on SiO₂ waveguides of width 220 nm or 400 nm and height 340 nm or 220 nm set apart at a distance g between their centerlines. In FIG. 8(b) the symmetric β₊ and antisymmetric modes of the coupled waveguides are shown as a function of g for an input wavelength of λ=1310 nm or λ=1550 nm. In FIG. 8(c) the resulting coupling parameter is shown as a function of g.

In FIG. 9(a) the FDE calculation of the propagation constant of a single waveguide of width w is shown. In FIG. 9(b) the propagation constant of a single waveguide βᵢ is given as a function of its width wi. In FIG. 9(c) the resulting detuning of a coupled waveguide system is given as a function of the difference in their widths δ, where the width of waveguide 1 is w and the width of waveguide 2 is w±δ.

In order to incorporate a phase-mismatch (detuning), we increase or decrease the base width w=w₀±δ to create a positive or negative detuning value. The propagation constant for each individual waveguide βᵢ is calculated via a FDE solver for each width wᵢ to evaluate the resulting detuning Δ=(β₁−β₂)/2 (FIGS. 9(a)-(c)). The detuning values Δ normalized by the relevant coupling κ are used to assess the relevant differences in width δ that are required for the detuning modulation. The implementation of detuning-modulated CSs on coupled waveguides is based on the coupled mode equations, therefore the values δ achieved here are only an approximation to the exact ones of the actual light propagation. Therefore, δ is tweaked via an iterative eigenmode expansion (EME) simulation process or optimization algorithm or analytical solution to achieve the correct values. Since detuning-modulated CSs are robust to systematic errors, which include target detuning values, the iterative process is short and straightforward. The advantages of integrated photonic systems based on universal detuning of modulated composite pulses, as mentioned above, are the high fidelity of quantum operations achieved by a design that is robust to systematic errors. These appeal to various applications, such as quantum computation hardware, NMR, sensors, crystal design for high harmonic generation and integrated circuits design.

Components for robust quantum computation design may be provided with a high fidelity fit for QIP fault tolerance, and may be insensitive or less sensitive to the system's initial state, therefore enabling highly accurate gate operations.

Reference is now made to FIGS. 8(d)-8(f) and FIGS. 9(d) to 9(f), which illustrate the same detuning process by changing the refractive index, typically by changing the doping. The embodiments so far have been described using undoped waveguides, or without referring to the doping. However, the refractive index, which effects the mode-index of the waveguide may thus influence the propagation constant and the detuning. The propagation constant may thus be affected by the doping of the waveguide or by free carrier or currents that are being applied to the waveguides. The doping modifies the effective energy gap of the materials, specifically in the current dependence of direct or indirect bandgap semiconductors. The doping can be with positive or negative doping (such as donor and acceptor impurities of n type and p type silicon semiconductor materials). Changes in the optical bandgaps (and thus the refractive index) may be achieved by other means, such as photonics crystals, nanostructures, impurities, metamaterials, and effective media. Also free carriers that are injected electronically or optically to the waveguide or near waveguide may influence the refractive index of the waveguide, and thus the detuning or the coupling coefficient parameter.

There now follow embodiments which are robust to both amplitude and phase and thus provide for unitary functions.

In the following, as before, the embodiments may provide two complementary methods to obtain unitary gates: analytically and numerically. For each case we provide embodiments of single- and two-qubit unitary gate operations, which offer a set of quantum gates for a functional quantum information processor.
Specifically, in the single qubit gate operator, we provide embodiments for an X-gate (X-pauli gate),

$${X}^{\frac{1}{2}} - gate , {X}^{\frac{1}{3}} - gate , {X}^{\frac{1}{N}} - gate ,$$

H-gate (Hadamard gate), T-gate
In the two qubit gates, we list C-NOT gate (control-NOT gate) and the Controlled-Z gate.

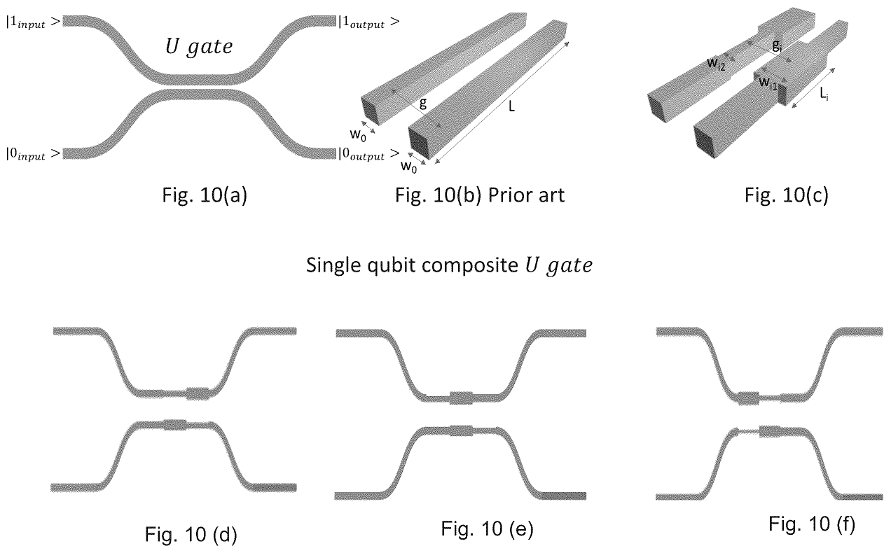

Reference is now made to FIGS. 10(a)-10(f), which show a set of quantum logic gates that may be constructed according to the present embodiments. In this case the gates provide for single qubit operation. In FIG. 10(a) a schematic top-down view of a directional coupler, which is a building block for an arbitrary single qubit operation. FIG. 10(b) shows a zoomed-in version of the coupling region in a traditional coupler with uniform width and unchanging separation across the entire interaction length, while (c) shows schematically a composite segment-based design according to the present embodiment. The design of FIG. 10A-F is composed of a discrete number of segments, each segment being defined by its own physical design parameters, which consequently define the interaction. The parameters remain constant for the entire length of this segment: w₁ᵢ, w₂ᵢ, gᵢ, Lᵢ for each i≤N, where N is the number of segments. FIGS. 10(d)-10(f) show specific implementations of single qubit composite gates in a robust manner. These gates are:

$${X}^{\frac{1}{n}} ,$$

Hadamard, and T gates, respectively. In each case lengths or segments of different width are shown. In each of FIG. 10(d)-FIG. 10(f) three segments are present in the coupling region in different configurations,

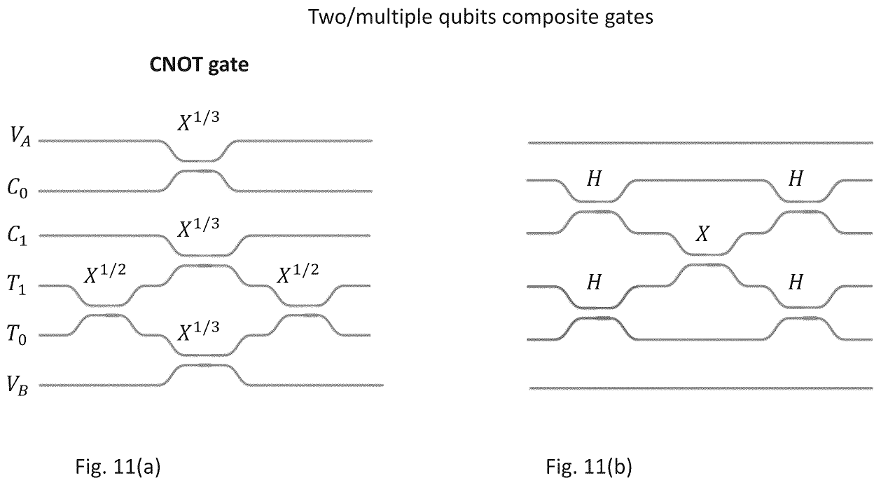

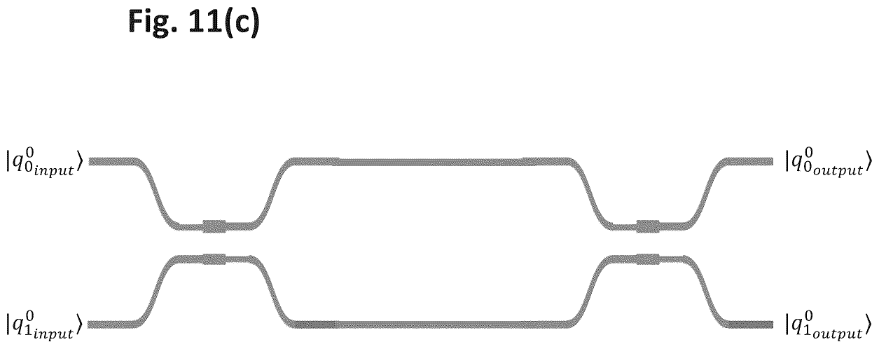

Reference is now made to FIGS. 11(a) and 11(b) which schematically show gates for dual qubit operations in integrated photonics, utilizing composite segment design. FIG. 11(a) shows a CNOT entangling gate is displayed and FIG. 11(b) shows a composite implementation of a CZ gate. For dual qubit operations, six waveguides are required.

Reference is now made to FIG. 11(c), which illustrates a Mach Zender interferometer constructed according to embodiments of the present invention, that is to say with coupling areas comprising differentiated segments. The method and embodiments described herein are applicable to the step-wise design of optical waveguides with dual-rail realization to improve the fidelity and robustness of quantum devices that are particularly sensitive to errors in the quantum state or quantum unitary operation.

Many classical devices, which include directional coupler devices, also require fidelity in the desired functionality, say coupling ratio between two or more waveguides, and accordingly may use segmented coupling areas in accordance with the present embodiments. The devices and applications include but are not limited to: accurately balanced or non-balanced Mach-Zehnder interferometers for various sensing applications, Mach Zehnder modulators for switches, ring resonators for accurate cavity control in laser, Waveguide based Light detection Radar (Lidars), power dividers, and an N×N multiplexer/demultiplexer.

Any implementation for a coupling ratio or unitary rotation that is more robust for variations in geometry, temperature, doping, polarizations, etc., for the quantum domain will exhibit the same resiliency properties in the classical limit as well and, of course, in the quantum domain when used in integrated photonics devices, even if not for quantum state processing.

It is noted that, once a unitary transformation in general, or a coupling ratio in particular, between the waveguide has been defined and error statics on input and manufacturing parameters identified, the same methodology described herein can be used to design the CS parameters for the waveguides.

### General Framework

In the following we define the problem and the framework We will use:

$${e}^{i θ {u}_{i} {σ}_{i}} = cos θ + i sin θ {u}_{i} {σ}_{i} , {\sum }_{i} {u}_{i}^{2} = 1 .$$

### Single-Qubit Gate Product

Consider a single qubit rotation:

$${R}_{ϕ} ( θ ) = {e}^{- \frac{i θ}{2} {σ}_{ϕ ,}} ,$$

$$where$$

$${σ}_{ϕ} = cos ϕ X - sin ϕZ .$$

$$Then ,$$

$${R}_{ϕ} ( θ ) = ( \begin{matrix}cos \frac{θ}{2} + i sin ϕsin \frac{θ}{2} & - i cos ϕsin \frac{θ}{2} \\ - i cos ϕsin \frac{θ}{2} & cos \frac{θ}{2} - i sin ϕsin \frac{θ}{2}\end{matrix} ) = cos \frac{θ}{2} - i sin \frac{θ}{2} {σ}_{ϕ} .$$

Compare to the waveguide matrix:

$$U ( Ω , Δ , t ) = ( \begin{matrix}cos \frac{A}{2} + i \frac{Δ}{\sqrt{{Ω}^{2} + {Δ}^{2}}} sin \frac{A}{2} & - i \frac{Ω}{\sqrt{{Ω}^{2} + {Δ}^{2}}} sin \frac{A}{2} \\ - i \frac{Ω}{\sqrt{{Ω}^{2} + {Δ}^{2}}} sin \frac{A}{2} & cos \frac{A}{2} - i \frac{Δ}{\sqrt{{Ω}^{2} + {Δ}^{2}}} sin \frac{A}{2}\end{matrix} ) ,$$

we have:

$$A = θ = t \sqrt{{Ω}^{2} + {Δ}^{2}} , sin ϕ = \frac{Δ}{\sqrt{{Ω}^{2} + {Δ}^{2}}} , cos ϕ = \frac{Ω}{\sqrt{{Ω}^{2} + {Δ}^{2}}} .$$

While there are three waveguide parameters: t, Δ and Ω, we have only two independent variables θ and ϕ in the unitary matrix. Note also that

$$tan ϕ = \frac{Δ}{Ω} .$$

### Detuning Error

Consider the error in the X-gate and its fractional powers

$${X}^{\frac{1}{2}} and {X}^{\frac{1}{3}} . For {X}^{\frac{1}{n}}$$

we may take in ([SQ])

$$θ = \frac{π}{n}$$

and φ=0. Define the detinung error δΔ=ϵ. The errors to first order: δθ=δcosφ=0,

$$δ sin ϕ = δ ϕ = \frac{ϵ}{Ω} .$$

Multiply several matrices i=1, . . . , N with errors δθᵢ, δφᵢ with the X gate and collect the first order error. Derive the equations for its cancellation.
Note that the errors δθᵢ, δφᵢ are different for different i:

$$δ {θ}_{i} = \frac{{θ}_{i} {Δ}_{i} ϵ}{{Ω}_{i}^{2} + {Δ}_{i}^{2}} , {δϕ}_{i} = \frac{{Ω}_{i} ϵ}{{Ω}_{i}^{2} + {Δ}_{i}^{2}} .$$

In fact,

δθᵢ=θᵢtanφᵢδφᵢ.

### Error Matrix at First Order

$${R}_{ϕ + δ ϕ} ( θ + δ θ ) = cos \frac{θ + δ θ}{2} - i sin \frac{θ + δ θ}{2} {σ}_{ϕ + δ ϕ} .$$

At first order we get

$${R}_{ϕ + δ ϕ} ( θ + δ θ ) = {R}_{ϕ} ( θ ) + A + BX + CZ + O ( {ϵ}^{2} ) ,$$

$$where ,$$

$$A = - \frac{1}{2} sin \frac{θ}{2} δ θ$$

$$B = - \frac{i}{2} cos \frac{θ}{2} cos ϕ δθ + i sin \frac{θ}{2} sin ϕ δ ϕ$$

$$C = \frac{i}{2} cos \frac{θ}{2} sin ϕ δθ + i sin \frac{θ}{2} cos ϕ δ ϕ$$

For the X gate we have

$$- i X = {e}^{- \frac{i π}{2} X} \to {e}^{- \frac{i π}{2} ( X - \frac{ϵ}{Ω} Z )} = - i ( X - \frac{ϵ}{Ω} Z ) + O ( {ϵ}^{2} ) .$$

The segment sequence has to fix the

$$\frac{ϵ}{Ω} Z$$

term.

### Fidelity Optimization Solutions

Using optimization algorithms, we obtained several sets of Δᵢ and Ωᵢ and parameters for three segment solutions which estimate X,

$${X}^{\frac{1}{2}} , {X}^{\frac{1}{3}} ,$$

H, T gates with higher precision than the analytic parameters we described in previous sections.
Furthermore, for each gate we obtained a set of Δᵢ and Ωᵢ and parameters for four segment solutions as well.
The units of Δᵢ and Ωᵢ are

$$[ \frac{1}{mm} ] ,$$

and as described in previous sections, the detuning error δΔ has a normal distribution, with a mean value of μ˜0, and a standard deviation of

$$σ ∼ 0. 5 [ \frac{1}{mm} ] .$$

In graphs 12(a) to 19(c) we can see how the fidelity norm changes in correspondence to different error values, which lie in the range of [−3σ, 3σ], meaning between

$$- 1.5 [ \frac{1}{mm} ] and 1.5 [ \frac{1}{mm} ] .$$

The fidelity is calculated in the following way:

1−|Tr((U_{ideal})⁺U)|

Where U is the estimating operator and U_{ideal} is the error-less operator.

### X Gate Estimation

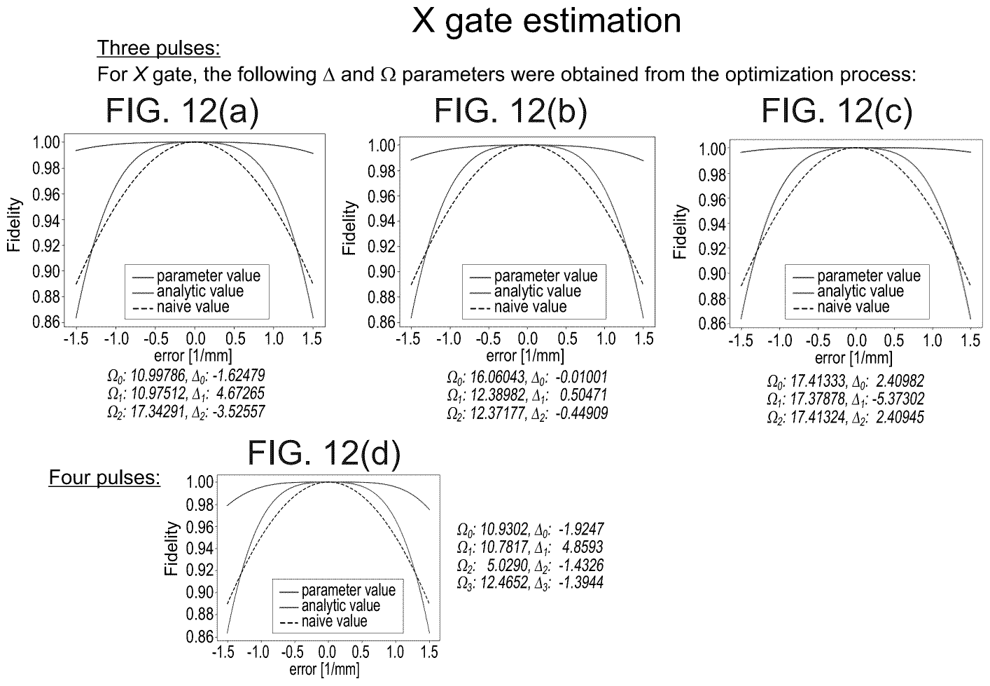

FIGS. 12(a) to 12(c) show an X gate having three segments and FIG. 12(d) shows the same for four segments.
For the X gate, the following Δ and Ω parameters were obtained from the optimization process:
The naïve parameters we used for the optimization are [π, 0] and the analytic parameters we used are the same as described in the previous section

$$[ \frac{π}{\sqrt{2}} , \frac{π}{\sqrt{2}} , π , 0 , \frac{π}{\sqrt{2}} , - \frac{π}{\sqrt{2}} ] .$$

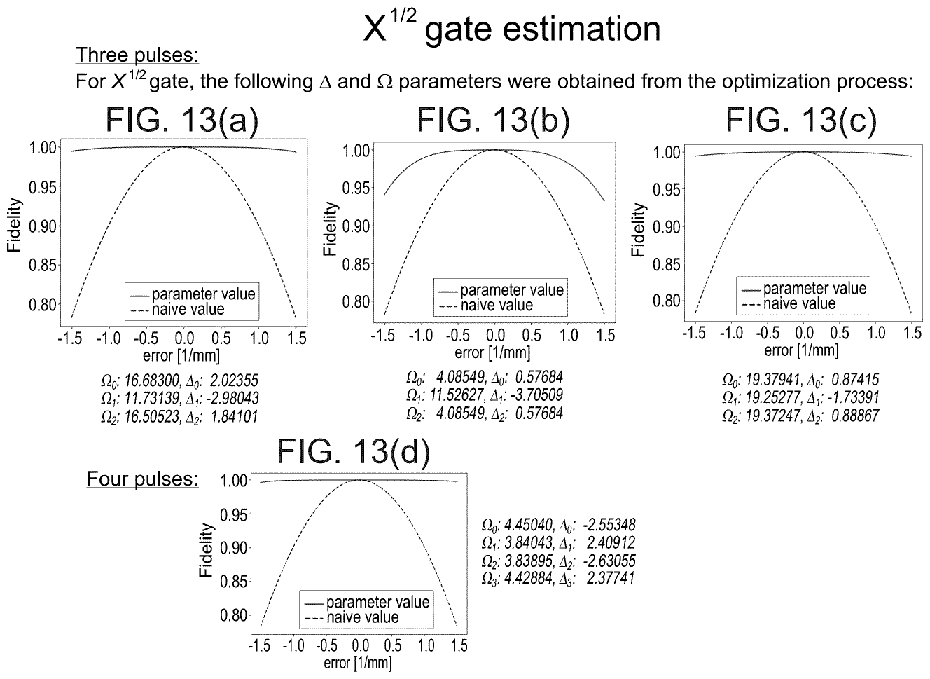

Reference is now made to FIGS. 13(a) to 13(d) which show

$${X}^{\frac{1}{2}}$$

gate estimation.

### For

$${X}^{\frac{1}{2}}$$

gate, the following Δ and Ω parameters were obtained from the optimization process, firstly for the three segment cases in FIGS. 13(a) to 13(c):

| | | |
|---|---|---|
| Ω₀: 16.68300, [symbol] ₀: 2.02355 | Ω₀: 4.08549, [symbol] ₀: 0.57684 | Ω₀: 19.37941, [symbol] ₀: 0.87415 |
| Ω₁: 11.73139, [symbol] ₁: −2.98043 | Ω₁: 11.52627, [symbol] ₁: −3.70509 | Ω₁: 19.25277, [symbol] ₁: −1.73391 |
| Ω₂: 16.50523, [symbol] ₂: 1.84101 | Ω₂: 4.08549, [symbol] ₂: 0.57684 | Ω₂: 19.37247, [symbol] ₂: 0.88867 |

Finally, the parameters for the Four segment case in FIG. 13(d) was:

Ω₀: 4.45040, Δ₀: −2.55348

Ω₁: 3.84043, Δ₁: 2.40912

Ω₂: 3.83895, Δ₂: −2.63055

Ω₃: 4.42884, Δ₃: 2.37741

The naïve parameters we used for the optimization are

$$[ \frac{π}{2} , 0 ] .$$

$${X}^{\frac{1}{3}} gate estimation$$

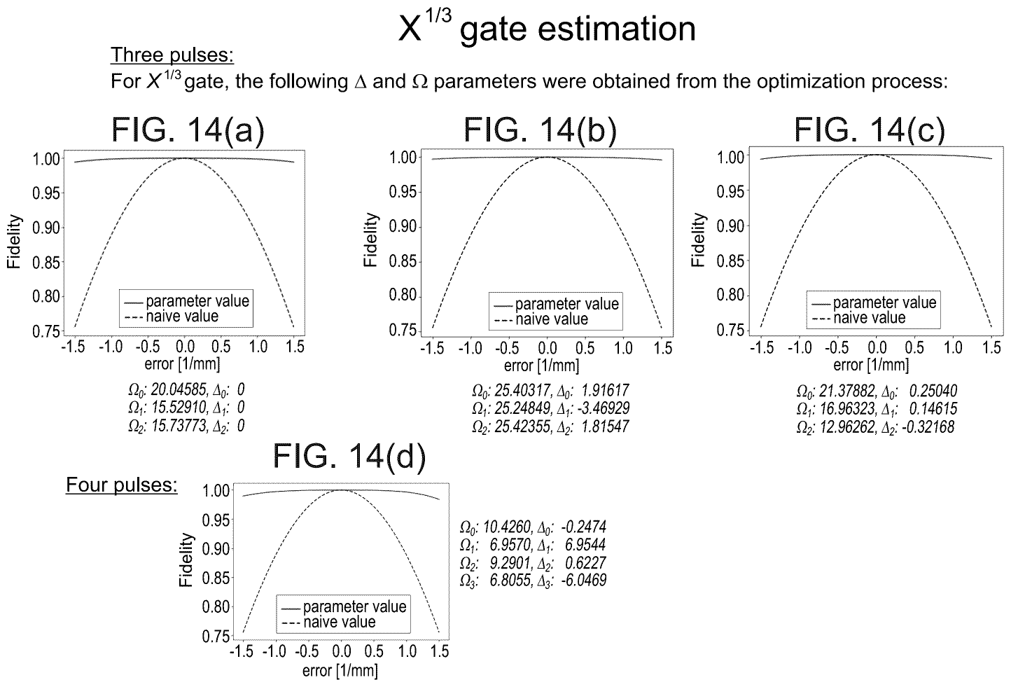

Referring now to FIGS. 14(a) to 14(c) results are shown for a 3 segment

$${X}^{\frac{1}{3}}$$

gate, and the following Δ and Ω parameters were obtained from the optimization process:

| | | |
|---|---|---|
| Ω₀: 20.04585, [symbol] ₀: 0 | Ω₀: 25.40317, [symbol] ₀: 1.91617 | Ω₀: 21.37882, [symbol] ₀: 0.25040 |
| Ω₁: 15.52910, [symbol] ₁: 0 | Ω₁: 25.24849, [symbol] ₁: −3.46929 | Ω₁: 16.96323, [symbol] ₁: 0.14615 |
| Ω₂: 15.73773, [symbol] ₂: 0 | Ω₂: 25.42355, [symbol] ₂: 1.81547 | Ω₂: 12.96262, [symbol] ₂: −0.32168 |

For the four segment case as shown in FIG. 14(d):

Ω₀: 10.4260, Δ₀: −0.2474

Ω₁: 6.9470, Δ₁: 6.9544

Ω₂: 9.2901, Δ₂: 0.6227

Ω₃: 6.8055, Δ₃: −6.0469

The naïve parameters we used for the optimization are

$$[ \frac{π}{3} , 0 ] .$$

### H Gate Estimation

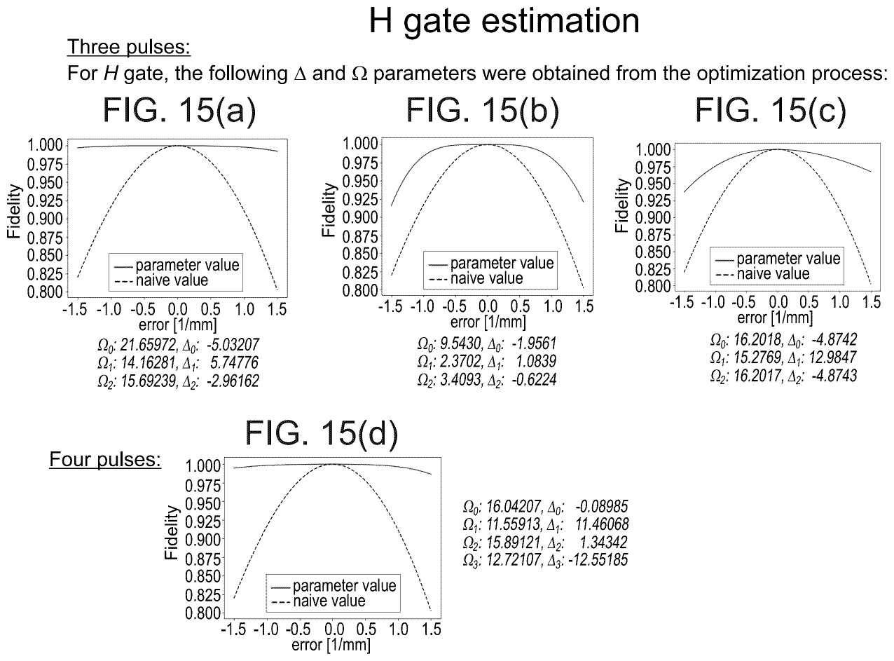

Referring now to FIGS. 15(a) to 15(d), for the H gate, the following Δ and Ω parameters were obtained from the optimization process:

| | | |
|---|---|---|
| Ω₀: 21.65972, [symbol] ₀: −5.03207 | Ω₀: 9.5430, [symbol] ₀: −1.9561 | Ω₀: 16.2018, [symbol] ₀: −4.8742 |
| Ω₁: 14.16281, [symbol] ₁: 5.74776 | Ω₁: 2.3702, [symbol] ₁: 1.0839 | Ω₁: 15.2769, [symbol] ₁: 12.9847 |
| Ω₂: 15.69239, [symbol] ₂: −2.96162 | Ω₂: 3.4093, [symbol] ₂: −0.6224 | Ω₂: 16.2017, [symbol] ₂: −4.8743 |

For the four segment case in FIG. 15(d):

Ω₀: 16.04207, Δ₀: −0.08985

Ω₁: 11.55913, Δ₁: 11.46068

Ω₂: 15.89121, Δ₂: 1.34342

Ω₃: 12.72107, Δ₃: −12.55185

The naïve parameters we used for the optimization are

$$[ - \frac{π}{2} , \frac{π}{2} ] .$$

### T Gate Estimation

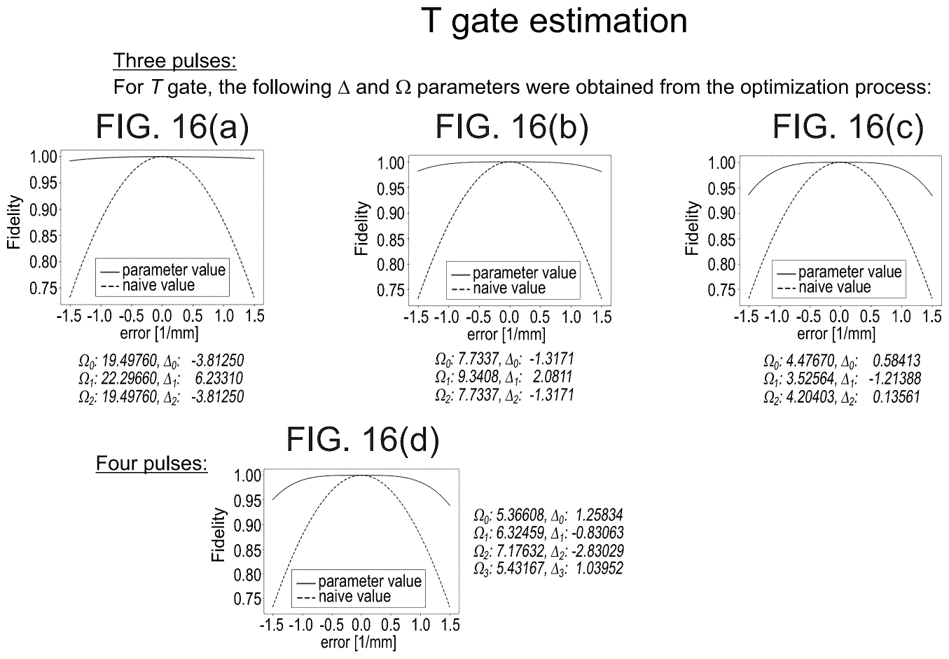

Reference is now made to FIGS. 16(a) to 16(d) which illustrate results for a T gate, where the following Δ and Ω parameters were obtained from the optimization process:

| | | |
|---|---|---|
| Ω₀: 19.49760, [symbol] ₀: −3.81250 | Ω₀: 7.7337, [symbol] ₀: −1.3171 | Ω₀: 4.47670, [symbol] ₀: 0.58413 |
| Ω₁: 22.29660, [symbol] ₁: 6.23310 | Ω₁: 9.3408, [symbol] ₁: 2.0811 | Ω₁: 3.52564, [symbol] ₁: −1.21388 |
| Ω₂: 19.49760, [symbol] ₂: −3.81250 | Ω₂: 7.7337, [symbol] ₂: −1.3171 | Ω₂: 4.20403, [symbol] ₂: 0.13561 |

For the four segment case in FIG. 16(d) the parameters were:

Ω₀: 5.36608, Δ₀: 1.25834

Ω₁: 6.32459, Δ₁: −0.83063

Ω₂: 7.17632, Δ₂: −2.83029

Ω₃: 5.43167, Δ₃: 1.03952

The naïve parameters we used for the optimization are

$$[ 0 , \frac{15 π}{16} ] .$$

Please note that even though these values aren't physically feasible, they create a T gate with a single matrix. It is noted that this is just one example of many possible solutions, and this observation applies to the solution for the T gate and to the solutions provided herein for all other gates.

### CNOT Gate Estimation

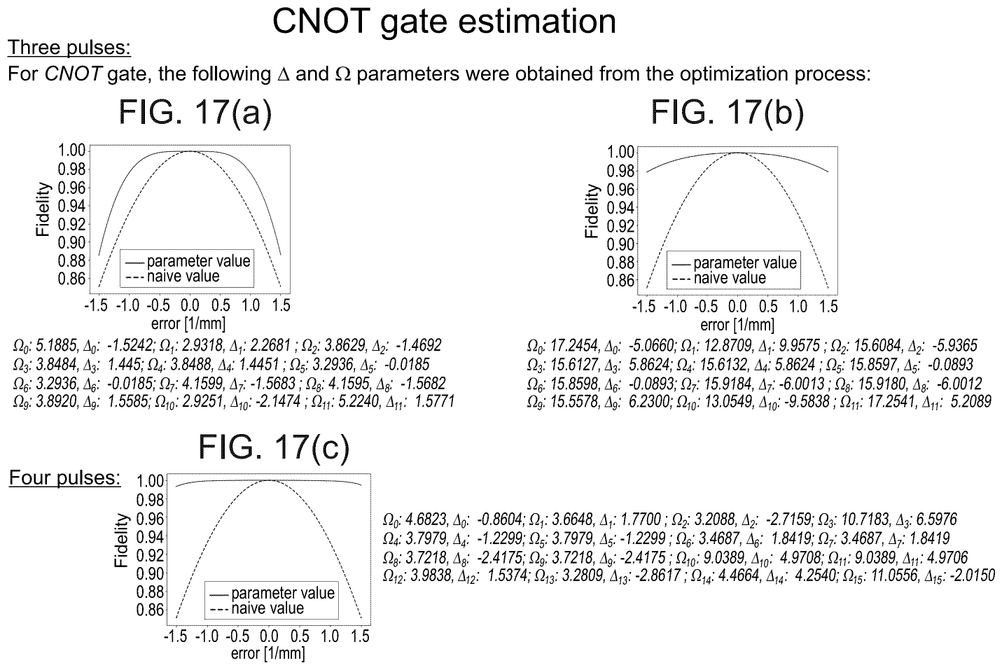

Reference is now made to FIGS. 17(a) to 17(c). A non-deterministic CNOT gate can be implemented by using multiple single qubit gates, specifically

$${X}^{\frac{1}{3}} and {X}^{\frac{1}{2}}$$

gates. An optimization for a single qubit

$${X}^{\frac{1}{3}}$$

gate (the uncorrelated part of the CNOT gate) was described hereinabove. At this point we use the optimization process in order to acquire parameters relevant to the correlated part of the CNOT gate only.
Since the single qubits gates from which we construct the probabilistic CNOT gate are correlated, we can consider their errors as the same instance of the error probability distribution function. This improves the fidelity of the CNOT gate compared to the uncorrelated errors case.
Each of the matrices which comprise the CNOT gate, U1, U2 and U3, were built using 3 segments, which means the total number of parameters we got is 24 (12 ωᵢ values and 12 Δᵢ values). The following Δ and Ω parameters were obtained from the optimization process:

FIG. 17(a)

Ω₀: 5.1885, Δ₀: −1.5242; Ω₁: 2.9318, Δ₁: 2.2681;
Ω₂: 3.8629, Δ₂: −1.4692
Ω₃: 3.8484, Δ₃: 1.445; Ω₄: 3.8488, Δ₄: 1.4451;
Ω₅: 3.2936, Δ₅: −0.0185
Ω₆: 3.2936, Δ₆: −0.0185; Ω₇: 4.1599, Δ₇: −1.5683;
Ω₈: 4.1595, Δ₈: −1.5682
Ω₉: 3.8920, Δ₉: 1.5585; Ω₁₀: 2.9251, Δ₁₀: −2.1474;
Ω₁₁: 5.2240, Δ₁₁: 1.5771

FIG. 17(b)

Ω₀: 17.2454, Δ₀: −5.0660; Ω₁: 12.8709, Δ₁: 9.9575;
Ω₂: 15.6084, Δ₂: −5.9365
Ω₃: 15.6127, Δ₃: 5.8624; Ω₄: 15.6132, Δ₄: 5.8624;
Ω₅: 15.8597, Δ₅: −0.0893
Ω₆: 15.8598, Δ₆: −0.0893; Ω₇: 15.9184, Δ₇: −6.0013;
Ω₈: 15.9180, Δ₈: −6.0012
Ω₉: 15.5578, Δ₉: 6.2300; Ω₁₀: 13.0549, Δ₁₀: −9.5838;
Ω₁₁: 17.2541, Δ₁₁: 5.2089

Four segments:

FIG. 17(c)

FIG. 17(c)

Ω₀: 4.6823, Δ₀: −0.8604; Ω₁: 3.6648, Δ₁: 1.7700;
Ω₂: 3.2088, Δ₂ −2.7159; Ω₃: 10.7183, Δ₃: 6.5976
Ω₄: 3.7979, Δ₄: −1.2299; Ω₅: 3.7979, Δ₅: −1.2299;
Ω₆: 3.4687, Δ₆: 1.8419; Ω₇: 3.4687, Δ₇: 1.8419
Ω₈: 3.7218, Δ₈: −2.4175; Ω₉: 3.7218, Δ₉: −2.4175;
Ω₁₀: 9.0389, Δ₁₀: 4.9708; Ω₁₁: 9.0389, Δ₁₁: 4.9706
Ω₁₂: 3.9838, Δ₁₂: 1.5374; Ω₁₃: 3.2809, Δ₁₃: −2.8617;
Ω₁₄: 4.4664, Δ₁₄: 4.2540; Ω₁₅: 11.0556, Δ₁₅: −2.0150

The naïve parameters used for the optimization are the naïve parameters used for the single qubit gates mentioned in previous sections

### CZ Gate Estimation

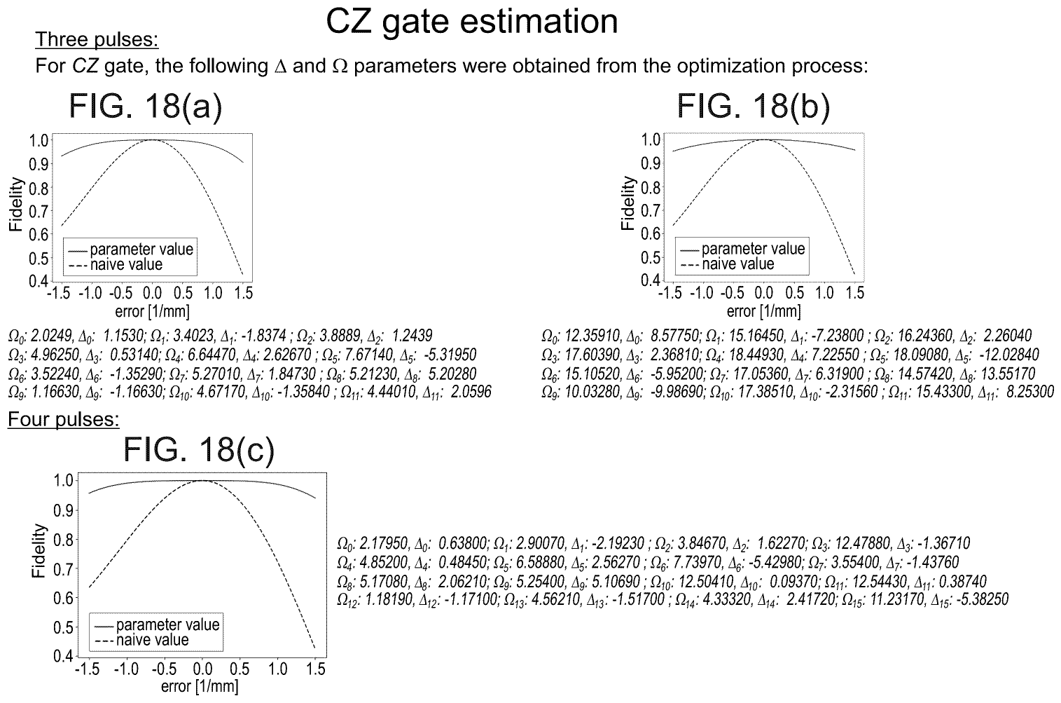

Referring now to FIGS. 18(a)-18(c), as described in previous subsection, a non-deterministic CNOT gate can be implemented by using a single qubit

$${X}^{\frac{1}{3}}$$

gate, and a fusion gate comprised of

$${X}^{\frac{1}{2}} and {X}^{\frac{1}{3}}$$

gates. In order to implement the CZ gate, an H gate was added to the target qubit before and after the CNOT gate. Each of the Matrices which comprise the fusion gate, U1, U2 and U3, were built using 3 segments, meaning the total number of parameters we got is 24 (12 Ωᵢ values and 12 Δᵢ values). The following Δ and Ω parameters were obtained from the optimization process:

FIG. 18(a)

Ω₀: 2.0249, Δ₀: 1.1530; Ω₁: 3.4023, Δ₁: −1.8374;
Ω₂: 3.8889, Δ₂: 1.2439
Ω₃: 4.96250, Δ₃: 0.53140; Ω₄: 6.64470, Δ₄: 2.61670;
Ω₅: 7.67140, Δ₅: −5.31950
Ω₆: 3.52240, Δ₆: −1.35290; Ω₇: 5.27010, Δ₇: 1.84730;
Ω₈: 5.21230, Δ₈: 5.20280
Ω₉: 1.16630, Δ₉: −1.16630; Ω₁₀: 4.67170, Δ₁₀: −1.35840;
Ω₁₁: 4.44010, Δ₁₁: 2.05960

FIG. 18(b)

Ω₀: 12.35910, Δ₀: 8.57750; Ω₁: 15.16450, Δ₁: −7.23800;
Ω₂: 16.24360, Δ₂: 2.26040
Ω₃: 17.60390, Δ₃: 2.36810; Ω₄: 18.44930, Δ₄: 7.22550;
Ω₅: 18.09080, Δ₅: −12.02840
Ω₆: 15.10520, Δ₆: −5.95200; Ω₇: 17.05360, Δ₇: 6.31900;
Ω₈: 14.57420, Δ₈: 13.55170
Ω₉: 10.03280, Δ₉: −9.98690; Ω₁₀: 17.38510, Δ₁₀: −2.31560;
Ω₁₁: 15.43300, Δ₁₁: 8.25300

Four segments:

FIGS. 18(c)

FIG. 18(c)

Ω₀: 2.17950, Δ₀: 0.63800; Ω₁: 2.90070, Δ₁: −2.19230;
Ω₂: 3.84670, Δ₂: 1.62270; Ω₃: 12.47880, Δ₃: −1.36710
Ω₄: 4.85200, Δ₄: 0.48450; Ω₅: 6.58880, Δ₅: 2.56270;
Ω₆: 7.73970, Δ₆: −5.42980; Ω₇: 3.55400, Δ₇: −1.43760
Ω₈: 5.17080, Δ₈: 2.06210; Ω₉: 5.25400, Δ₉: 5.10690;
Ω₁₀: 12.50410, Δ₁₀: 0.09370; Ω₁₁: 12.54430, Δ₁₁: 0.38740
Ω₁₂: 1.18190, Δ₁₂: −1.17100; Ω₁₃: 4.56210, Δ₁₃: −1.51700;
Ω₁₄: 4.33320, Δ₁₄: 2.41720; Ω₁₅: 11.23170, Δ₁₅: −5.38250

The naïve parameters used for the optimization are the naïve parameters used for the single qubit gates mentioned in previous sections.

### Perturbative Error Correcting Solutions

In order to carry out error correction, we define

$$U = {e}^{- i \frac{t}{2} ( a \cdot {σ}_{ϕ} + ϵ \cdot {σ}_{φ} )}$$

for t, a, ϕ, φ∈ [symbol] . In can be proved that

$$U = {\sum }_{k = 0}^{∞} \frac{1}{k !} {( \frac{ϵ t}{2} )}^{k} {r}_{k} {U}_{k}$$

where |rₖ|≤1, Uₖ∈SU(2) ∀k. Therefore, defining the composite gate

$${U}_{k} := {e}^{- i \frac{{t}_{k}}{2} ( {a}_{k} \cdot {σ}_{{ϕ}_{k}} + {ϵ}_{k} \cdot {σ}_{{φ}_{k}} )}$$

$${U}^{( n )} := {U}_{1} {U}_{2} … {U}_{n}$$

We can show that

$${U}^{( n )} = {\sum }_{k = 0}^{∞} \frac{1}{k !} {( \frac{{ϵ}_{1} {t}_{1} + {ϵ}_{2} {t}_{2} + … + {ϵ}_{n} {t}_{n}}{2} )}^{k} {r}_{k}^{( n )} {U}_{k}^{( n )}$$

where |rₖ⁽ⁿ⁾|≤1, Uₖ⁽ⁿ⁾∈SU(2)∀K.

Notice that the previous results include any systematic error in the σ's; which includes errors in detunings, couplings and lengths.

Although the physical model might contain different distributions of the errors for the segments, if we take the model of ϵₖ to be up to the maximum error in any segment, it is sufficient to work up to some derivative: in order to make the errors vanish.

We work here with this cost function:

$$E ( ϵ ) := U ( ϵ ) - U ( 0 )$$

$$g ( ϵ ) := 1 - \frac{t r [ E ( ϵ ) {E}^{†} ( ϵ ) ]}{8} = \frac{1 + Re ( {U}_{11} ( 0 ) {U}_{11}^{*} ( ϵ ) + {U}_{12} ( 0 ) {U}_{12}^{*} ( ϵ ) )}{2}$$

### Example: The iX Gate

Analytical solutions for 3 segments are:

| | | | | |
|---|---|---|---|---|
| sol1: | {Ω, Δ, t}_{1, 2 ,3} = | {1.0, 1.0, 2.22} | {1.0, 0, 3.14} | {1.0, −1.0, 2.22} |
| sol2: | {Ω, Δ, t}_{1, 2, 3} = | {1.0, 2.0, 1.4} | {2.5, 0, 1.25} | {1.0, −2.0, 1.4} |
| sol3: | {Ω, Δ, t}_{1, 2, 3} = | (1.0, 5.0, 0.616} | {13.0, 0, 0.241} | {1.0, −5.0, 0.616} |
| sol4: | {Ω, Δ, t}_{1, 2, 3} = | {1.0, 10.0, 0.312} | {50.5, 0, 0.0622} | {1.0, −10.0, 0.312} |
| sol5: | {Ω, Δ, t}_{1, 2, 3} = | {1.0, 15.0, 0.209} | {113., 0, 0.0278} | {1.0, −15.0, 0.209} |
| sol6: | {Ω, Δ, t}_{1, 2, 3} = | {1.0, 20.0, 0.156} | {200., 0, 0.0156} | (1.0, −20.0, 0.156} |
| sol7: | {Ω, Δ, t}_{1, 2, 3} = | {1.0, 25.0, 0.125} | {313., 0, 0.01} | {1.0, −25.0, 0.125} |
| sol8: | {Ω, Δ, t}_{1, 2, 3} = | {1.0, 30.0, 0.104} | {450., 0, 0.00697} | {1.0, −30.0, 0.104} |
| sol9: | {Ω, Δ, t}_{1, 2, 3} = | {1.0, 40.0, 0.0785} | {801., 0, 0.00392} | {1.0, −40.0, 0.0785} |
| sol10: | {Ω, Δ, t}_{1, 2, 3} = | {1.0, 50.0, 0.0628} | {125. 10¹, 0, 0.00251} | {1.0, −50.0, 0.0628} |

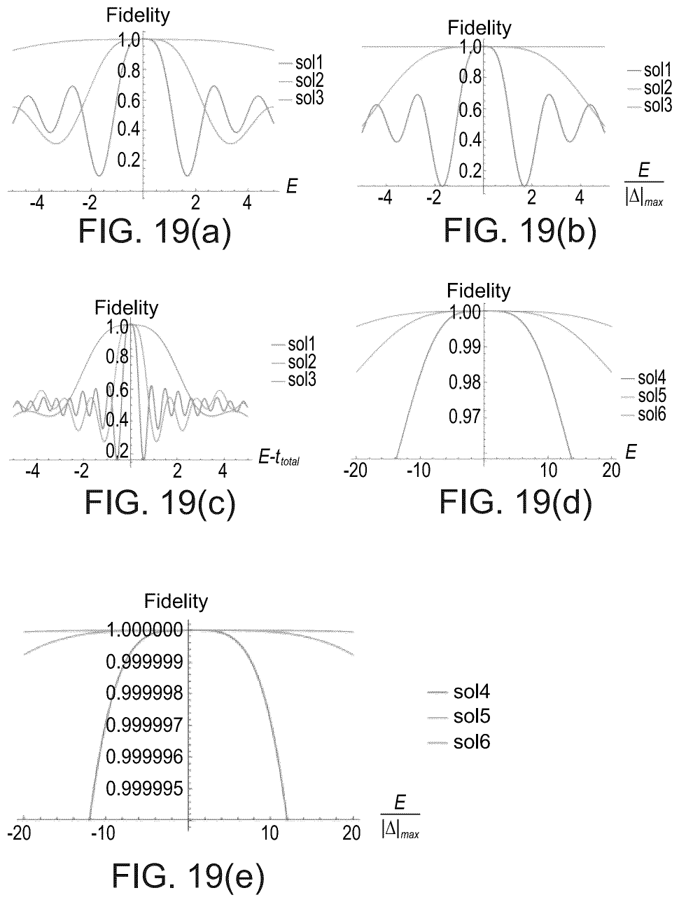

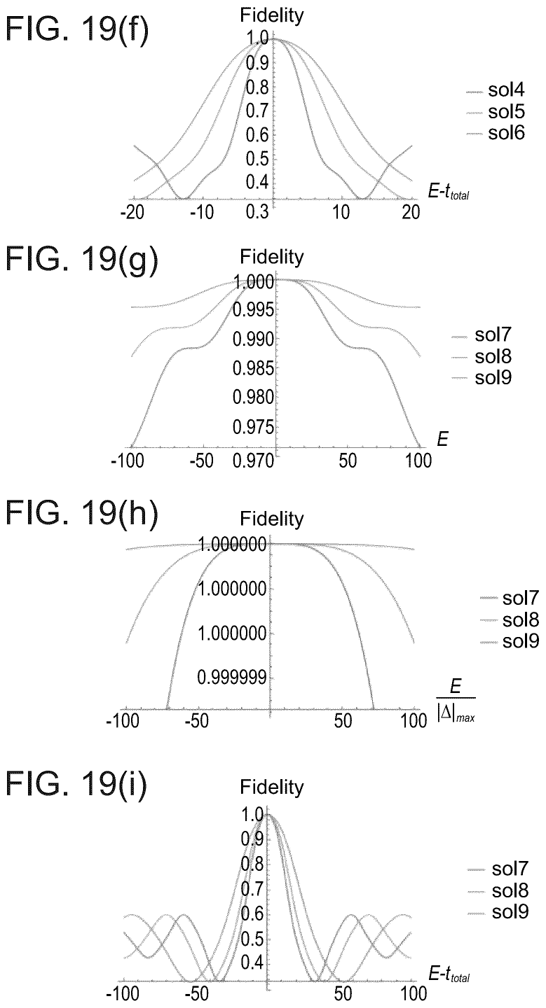

produce the graphs in FIGS. 19(a) to 19(i)
and comparing so14 to the numerical solution:

num: {Ω,Δ,t}_{1,2,3}={10.83439, −1.15648, 0.999999} {10.88307, 5.12423, 1} {17.43317, −3.72402, 0.29507323}

Produces the graphs in 20(a) to 20(c).

### Another Example: The (iX)^{1/2} Gate (Actually We Know How to Do (iX)^{1/n})

$$( \begin{matrix}sol 1 : & {\{ Ω , Δ , t \}}_{1 , 2 , 3} = & \{ 1. , 0 , 1.04 \} & \{ 3.7 3 , 0 , 2.38 \} & \{ 1. , 0 , 1.04 \} \\ sol 2 : & {\{ Ω , Δ , t \}}_{1 , 2 , 3} = & \{ 1. , 0 , 0.628 \} & \{ 3.52 , 0 , 2.76 \} & \{ 1. , 0 , 0.628 \} \\ sol 3 : & {\{ Ω , Δ , t \}}_{1 , 2 , 3} = & \{ 1. , 0 , 0.449 \} & \{ 3.9 8 , 0 , 2.53 \} & \{ 1. , 0 , 0.449 \} \\ sol 4 : & {\{ Ω , Δ , t \}}_{1 , 2 , 3} = & \{ 1. , 0 , 0.314 \} & \{ 4.8 4 , 0 , 2.14 \} & \{ 1. , 0 , 0.314 \} \\ sol 5 : & {\{ Ω , Δ , t \}}_{1 , 2 , 3} = & \{ 1. , 0 , 0.209 \} & \{ 6.3 7 , 0 , 1.66 \} & \{ 1. , 0 , 0.209 \} \\ sol 6 : & {\{ Ω , Δ , t \}}_{1 , 2 , 3} = & \{ 1. , 0 , 0.157 \} & \{ 7.9 4 , 0 , 1.34 \} & \{ 1. , 0 , 0.157 \} \\ sol 7 : & {\{ Ω , Δ , t \}}_{1 , 2 , 3} = & \{ 1. , 0 , 0.104 \} & \{ 11.1 , 0 , 0.972 \} & \{ 1. , 0 , 0.104 \} \\ sol 8 : & {\{ Ω , Δ , t \}}_{1 , 2 , 3} = & \{ 1. , 0 , 0.0628 \} & \{ 17.4 , 0 , 0.6 \; 23 \} & \{ 1. , 0 , 0.0628 \} \\ sol 9 : & {\{ Ω , Δ , t \}}_{1 , 2 , 3} = & \{ 1. , 0 , 0.0419 \} & \{ 25. 4 , 0 , 0.43 \} & \{ 1. , 0 , 0.0419 \} \\ sol 10 : & {\{ Ω , Δ , t \}}_{1 , 2 , 3} = & \{ 1. , 0 , 0.0314 \} & \{ 33. 3 , 0 , 0.328 \} & \{ 1. , 0 , 0.0314 \}\end{matrix} )$$

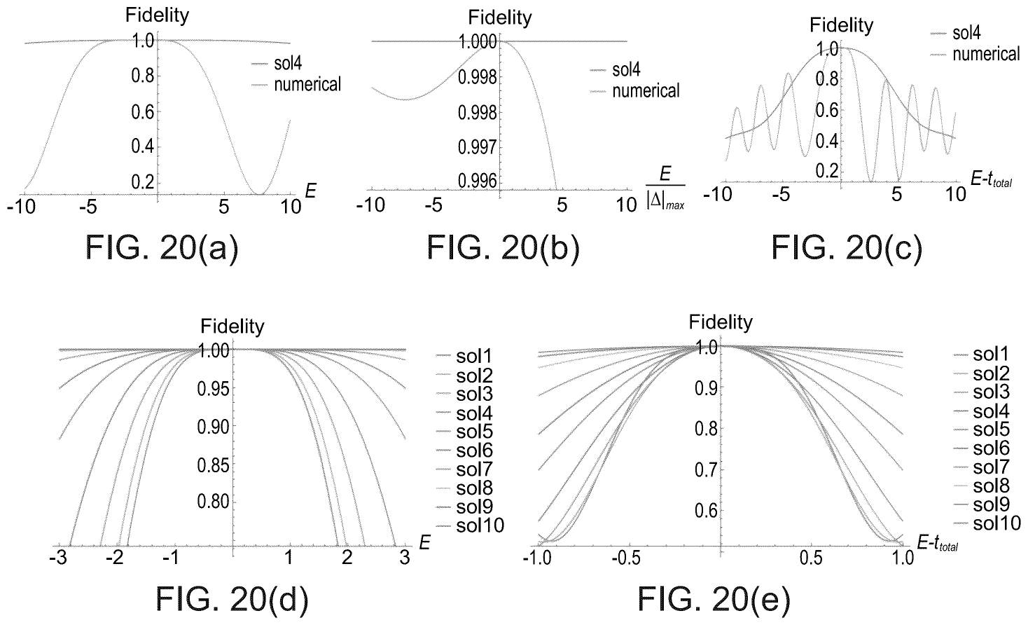

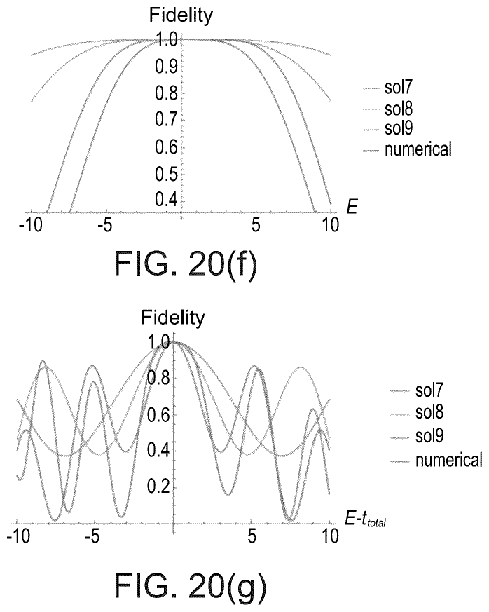

May produce the graphs in FIGS. 20(d) and 20(e).
Now, comparing so17,so18,so19 to the numerical solution:

$$num : {\{ Ω , Δ , t \}}_{1 , 2 , 3} = \{ 16.683 , 2. 02355 , 0.25 \; 2237 \} \{ 11. 73139 , - 2.98043 , 1 \} \{ 16.50523 , 1. 84101 , 0.243336 \}$$

May produce the graphs in FIGS. 20(f) and 20(g).

### Another Example: The (iX)^{1/3} Gate (Actually We Know How to Do (iX)^{1/n})

$$( \begin{matrix}sol 1 : & {\{ Ω , Δ , t \}}_{1 , 2 , 3} = & \{ 1. , 0 , 1.04 \} & \{ 2. , 0 , 4.71 \} & \{ 1. , 0 , 1.04 \} \\ sol 2 : & {\{ Ω , Δ , t \}}_{1 , 2 , 3} = & \{ 1. , 0 , 0.628 \} & \{ 2.21 , 0 , 4.64 \} & \{ 1. , 0 , 0.628 \} \\ sol 3 : & {\{ Ω , Δ , t \}}_{1 , 2 , 3} = & \{ 1. , 0 , 0.449 \} & \{ 2.53 , 0 , 4.19 \} & \{ 1. , 0 , 0.449 \} \\ sol 4 : & {\{ Ω , Δ , t \}}_{1 , 2 , 3} = & \{ 1. , 0 , 0.314 \} & \{ 3.05 , 0 , 3.56 \} & \{ 1. , 0 , 0.314 \} \\ sol 5 : & {\{ Ω , Δ , t \}}_{1 , 2 , 3} = & \{ 1. , 0 , 0.209 \} & \{ 3.95 , 0 , 2.8 \} & \{ 1. , 0 , 0.209 \} \\ sol 6 : & {\{ Ω , Δ , t \}}_{1 , 2 , 3} = & \{ 1. , 0 , 0.157 \} & \{ 4.86 , 0 , 2.3 \} & \{ 1. , 0 , 0.157 \} \\ sol 7 : & {\{ Ω , Δ , t \}}_{1 , 2 , 3} = & \{ 1. , 0 , 0.104 \} & \{ 6.7 , 0 , 1.69 \} & \{ 1. , 0 , 0.104 \} \\ sol 8 : & {\{ Ω , Δ , t \}}_{1 , 2 , 3} = & \{ 1. , 0 , 0.0628 \} & \{ 10.3 , 0 , 1.1 \} & \{ 1. , 0 , 0.0628 \} \\ sol 9 : & {\{ Ω , Δ , t \}}_{1 , 2 , 3} = & \{ 1. , 0 , 0.0419 \} & \{ 14.9 , 0 , 0.765 \} & \{ 1. , 0 , 0.0419 \} \\ sol 10 : & {\{ Ω , Δ , t \}}_{1 , 2 , 3} = & \{ 1. , 0 , 0.0314 \} & \{ 19.5 , 0 , 0.586 \} & \{ 1. , 0 , 0.0314 \}\end{matrix} )$$

Produces the graphs in 21(a) and 21(b).

### 4 Segments, Same Ω, iX Gate

$$( \begin{matrix}sol 1 : & {\{ Ω , Δ , t \}}_{1 , 2 , 3 , 4} = & \{ 1.004 \text{.71} \} & \{ 1. , 0.46097 , 5.70612 \} & \{ 1. , - 0.460967 , 5.70612 \} & \{ 1. , 0 , 4.71 \} \\ sol 2 : & {\{ Ω , Δ , t \}}_{1 , 2 , 3 , 4} = & \{ 1.004 \text{.71} \} & \{ 1. , 6.03285 , 1.02748 \} & \{ 1. , - 6.03285 , 1.0274761248 \} & \{ 1. , 0 , 4.71 \}\end{matrix} )$$

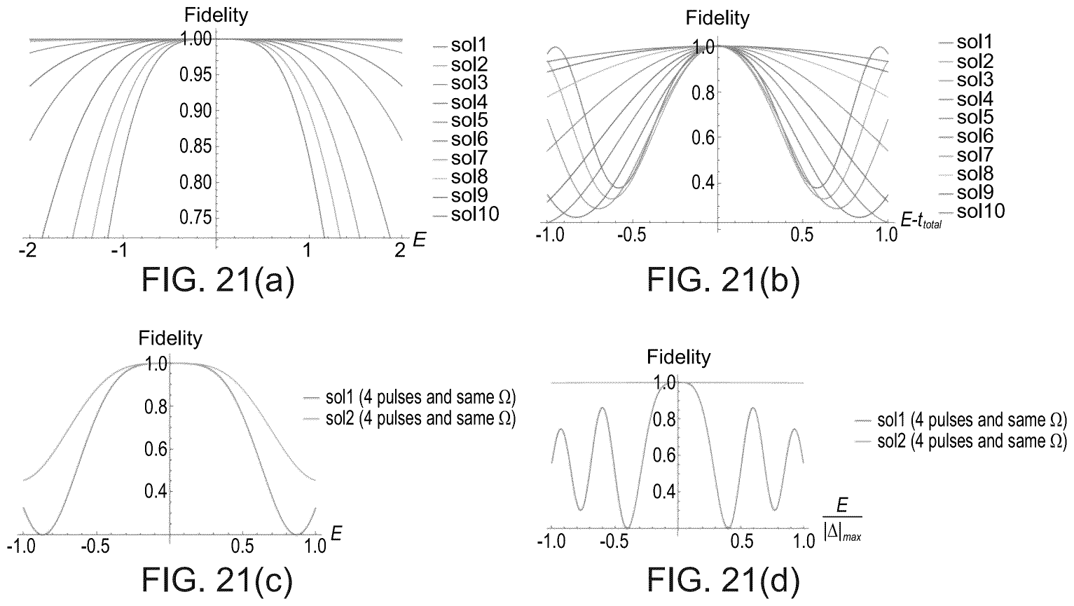

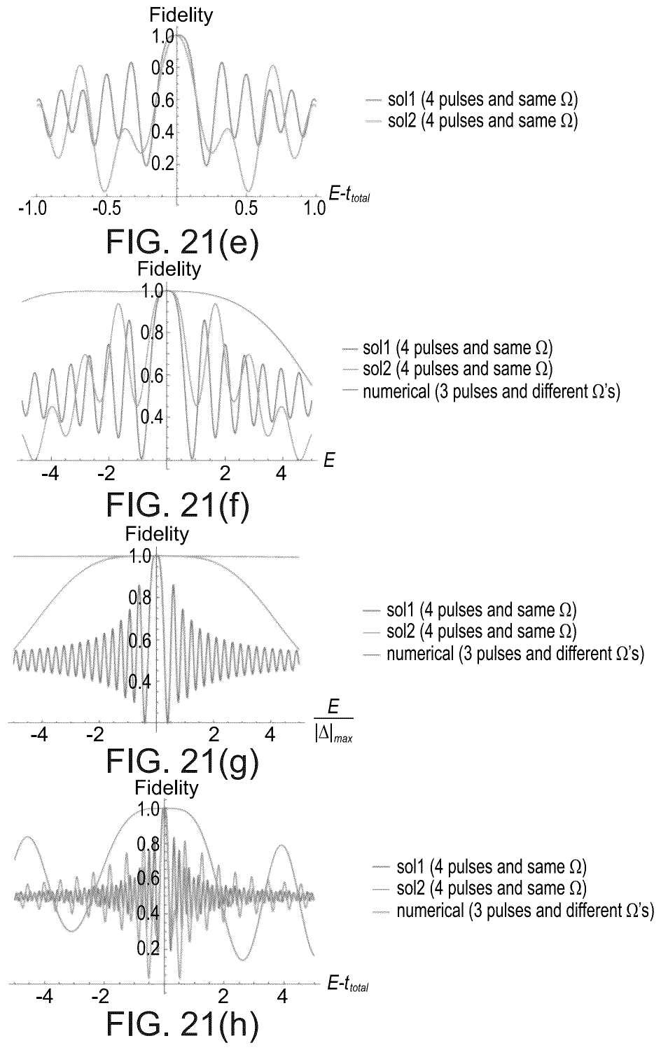

Gives the graphs in 21(c)-(e),
and comparing with the numerical solution of 3 segments with different Ω's (which is not necessarily the best):
gives the results in FIGS. 21(f)-21(h).

### 5 Segments, Same Ω, iX Gate

We can find more families of analytical solutions in 3 segments, 5 segments, more generally for N-segments, and 2-qubit gates may be obtained analytically. It is noted that the more segments the more degrees of freedom.

The components may be robust to errors, such as excitation intensity (i.e. segment strength), unwanted frequency chirp. The components may enable full scalability, may be tunable, and may achieve short coupling times and lengths.

### Error Distribution

When checking the following region of Ω values: [0.04817664, 0.05113868] and the following region of Δ values: [−0.04302465, 0.04541896], we found out that, on average, one standard deviation in the error distribution for these values was roughly 20% for Δ (meaning, δΔ˜0.2Δ) and roughly 10% for Ω (meaning, δΩ˜0.1Ω). This was true for the specific case of silicon on SiO₂ but may differ for other materials or even for the same materials made in different fabrication facilities.

Using these numbers, we ran an optimization algorithm on three composite pulses to minimize the coupling error alongside the detuning error for an X gate.

### Optimization Parameters and Graphs

The following parameters were derived from the optimization process:

| | | |
|---|---|---|
| Ω₁ = 0.044, | Δ₁ = 0.3831, | t₁ = 13.2623 |
| Ω₂ = 0.4499, | Δ₂ = −0.0307, | t₂ = 7.4246 |
| Ω₃ = 0.0418, | Δ₃ = 0.3764, | t₃ = 13.5054 |

In graphs 22(a) and 22(b), we can see the fidelity of the X gate for different coupling errors and detuning errors. The coupling errors and detuning errors are ranged between −2 standard deviations and 2 standard deviations

The parameters graph used the optimized parameters given from the optimization process while the naïve graph used the following parameters:

| | | |
|---|---|---|
| Ω₁ = 0.0508, | Δ₁ = 0, | t₁ = π/0.0508 |

As we can see in the graphs, while the naïve graph changes drastically when increasing the coupling error, the parameters graph shows more tolerance to coupling error while still remaining above 98% fidelity for detuning errors alone.

Furthermore, the naïve parameters were chosen specifically from the lowest point in the error distribution, meaning the range of error values in the naïve graph is significantly smaller than the parameter's graph.

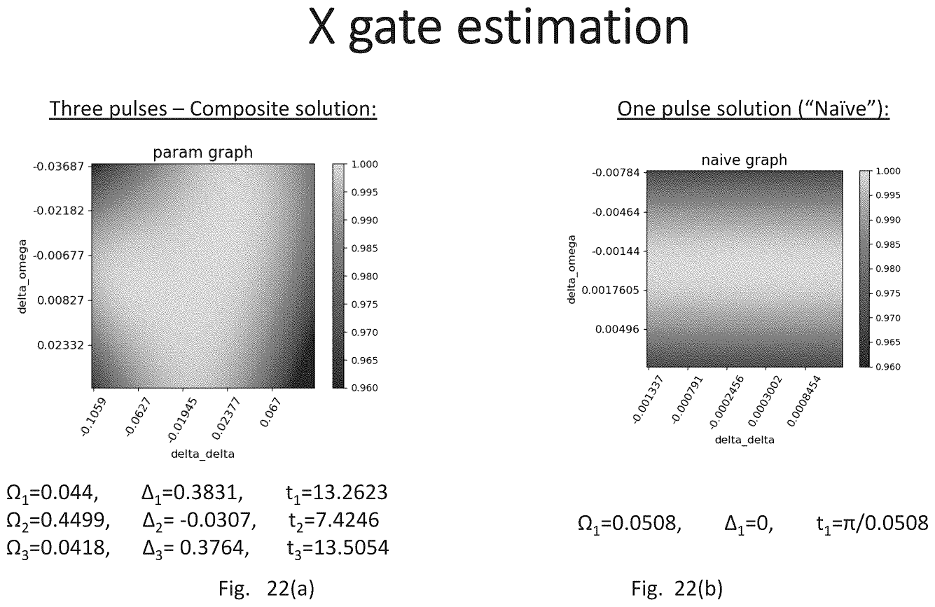

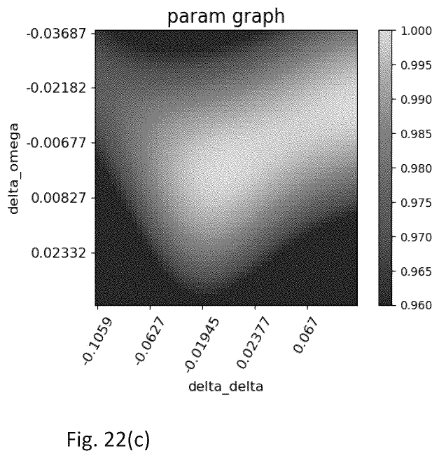

Lastly, the coupling and detuning errors shown in the graphs were correlated between all three segments. If the errors aren't correlated, we get the graph of FIG. 22(c).

As can be seen from FIG. 22(c), in the case where the errors are not correlated, the error tolerance of the three segments is much lower, as can be expected.

Prior art quantum components may be prone to real-valued fabrication errors. However, those of the present embodiments are or may be robust to fabrication errors in width (detuning), robust to fabrication errors in gap (coupling), robust to material doping (detuning and coupling), and may allow for full scalability for a minimal segment overhead.

Components according to the present embodiments may be designated for small circuit footprints, thus complete and robust coupling may occur for N>=3 steps, allowing for compact integration.

Full scalability may be available for any given design geometry, and may be adequate for crystal design for a high harmonic generation.

In the present disclosure, the terms pulses, segments, and steps are interchangeable, except that the term pulse relates to a transient signal and the term segment relates to a stationary geometrical structure built into a waveguide. In addition, the terms detuning, delta, and difference between mode-index are interchangeable. The terms Omega, kappa and coupling coefficient are interchangeable. The terms Time, and z and propagation length are interchangeable.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Furthermore, the methods to use CS as described herein are a framework to optimize the fidelity of a unitary transformation. As is obvious to a person skilled in the art, the same method of applying CS may be applied to some of the segments or optical coupling points and still come under the scope of the present embodiments. For example, in the description associated with FIG. 11A-C we describe one embodiment of using CS to optimize a CNOT gate design. It is possible to add a CS design to a subset of the optical couplings only and still provide improved resiliency. Finally it is also possible to extend the design to more than two optical rails coupled simultaneously

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety

What is claimed is:

1. A method for constructing a quantum gate for a unitary operation in photonic quantum information processing, comprising:
providing at least a first waveguide and a second waveguide;
calculating one or more segment parameters for segments within a coupling region, said one or more parameters relating to propagation constants of respective waveguides, said one or more parameters being different for said first and second waveguides respectively and thereby providing detuning between said first and second waveguides to allow for unitary operation between said first and second waveguides with high fidelity in the presence of errors;
building said segments into said respective waveguides; and
optically coupling said first and second waveguides at said coupling region, at least one of said building and said coupling being carried out using said one or more parameters, thereby to construct a quantum gate for a unitary operation.

2. The method of claim 1, wherein said one or more segment parameters comprise a parameter related to one member of the group comprising a width of one of said waveguides, a height of one of said waveguides, a refractive index of one of said waveguides, a doping level of one of said waveguides, and a distance between said first and second waveguides.

3. The method of claim 1, comprising providing each of said waveguides with a plurality of segments within said coupling region, each one of said segments being constructed according to a different segment parameter.

4. The method of claim 1, comprising using solutions for respective propagation constants wherein a number of said segments formed by respective calculated parameters is greater than or equal to two.

5. The method of claim 1, comprising making corrections to said one or more parameters using an analytical approach.

6. The method of claim 1, comprising making corrections to said at least one parameter using a numerical approach.

7. The method of claim 6, wherein said numerical approach is one member of the group consisting of an iterative eigenmode expansion (EME) simulation process to approach a desired detuning level, and using a finite difference eigenmode solver (FDE) to calculate a coupling parameter.

8. The method of claim 1, comprising changing a detuning parameter (δ), said δ and a change in δ being achieved by changing one of said segment parameters in said coupling region.

9. The method of claim 1, comprising changing a coupling parameter (Ω), a change in Ω being defined by changing one of said segment parameters in said coupling region.

10. The method of claim 8, comprising changing both said coupling parameter and said detuning parameter.

11. The method of claim 8, comprising using detuning values Δ normalized by a coupling parameter κ representing said optical coupling between said first and second waveguides, to obtain said δ for a given detuning modulation.

12. The method of claim 1, wherein said detuning comprises changing one of the segment parameters in discrete steps.

13. The method of claim 12, comprising using said discrete steps to arrive at a structure that allows universal rotations, said rotations being independent of an initial state of a system formed by said at least first and second waveguides being coupled.

14. The method of claim 1, comprising providing an error model based on fabrication limitations and selecting said parameters via a stepwise process to minimize errors under said model.

15. The method of claim 14, wherein said errors are systematic errors.

16. Quantum logic for unitary operation in quantum information processing comprising:
at least two optically coupled waveguides, coupled over a coupling area, the coupling area comprising at least two segments, the segments differing with respect to each other in respect of at least one segment parameter.

17. The quantum logic of claim 16, wherein said at least one segment parameter is one member of the group comprising a width of one of said waveguides, a height of one of said waveguides, a refractive index of one of said waveguides, a doping level of one of said waveguides, and a distance between said first and second waveguides.

18. The quantum logic of claim 17, wherein said segments and said optical coupling between said waveguides define detuning parameters δ and coupling parameters Ω, the segment parameters being selected to provide a detuned coupling between said first and second waveguides to provide reliable unitary operation between said first and second waveguides with high fidelity in the presence of errors.

19. The quantum logic of claim 16, wherein said first and second waveguides comprise Si on SiO₂, SiN, glass, or LiNBO₃ waveguides.

20. The quantum logic of claim 17, implementing one member of the group of logic gates comprising: an X gate, an H (Hadamard) gate, a
$${X}^{\frac{1}{n}} gate ,$$
a NOT gate, a CNOT gate, a Y gate, a Z gate, a CZ gate, an iX gate, and a T gate.

21. A method for constructing an integrated photonic device to perform a unitary operation, comprising:
providing at least a first waveguide and a second waveguide;
calculating one or more segment parameters for segments within a coupling region, said one or more parameters relating to propagation constants of respective waveguides, said one or more parameters being different for said first and second waveguides respectively and thereby providing detuning between said first and second waveguides to allow for unitary operation between said first and second waveguides with high fidelity in the presence of errors;
building said segments into said respective waveguides; and
optically coupling said first and second waveguides at said coupling region, at least one of said building and said coupling being carried out using said one or more parameters, thereby to construct a quantum gate for a unitary operation.

22. The method of claim 21, wherein said one or more segment parameters comprise respective members of the group comprising a width of one of said waveguides, and a distance between said first and second waveguides.
